(19) United States
(12) Patent Application Publication
(10) Pub. No.: US 2023/0162237 A1
(43) Pub. Date: May 25, 2023

(54) CONTENT SEQUENCES FOR USER CONTENT ITEM EXPLORATION

(71) Applicant: Hubspot, Inc., Cambridge, MA (US)

(72) Inventors: Michael Henry Pape, Bolton, MA (US); Jason Frade, Lyme, CT (US); Katie Koenig, Scottsdale, AZ (US); John Edward Vallerie, Somerville, MA (US); Ish Singh, Hayward, CA (US); Harsha Sabbath, Acton, MA (US); Jude Ankrah, Cypress, TX (US); Erica Lee McMonagle, Washington, DC (US); Tasneem Amreliwala, Waltham, MA (US); Jared Williams, Cambridge, MA (US)

(21) Appl. No.: 17/993,629

(22) Filed: Nov. 23, 2022

Related U.S. Application Data
(60) Provisional application No. 63/264,491, filed on Nov. 23, 2021.
(60) Provisional application No. 63/341,646, filed on May 13, 2022.

(51) Int. Cl. G06Q 30/0251; G06Q 30/0241; G06Q 30/0272; G06Q 30/0242

(52) U.S. Cl. CPC G06Q 30/0269; G06Q 30/0276; G06Q 30/0272; G06Q 30/0246; G06Q 30/01

(57) ABSTRACT

Techniques are provided for generating a content sequence of campaigns for providing users with content items. A first campaign of the content sequence is generated to include a first content item to display to a first audience of users. A second campaign of the content sequence is generated to include a second content item to display to a second audience of users that viewed the first content item. A third campaign of the content sequence is generated to include a third audience of users that interacted with the second content item. In this way, the content sequence is implemented to serve content items to users.

### RELATED APPLICATIONS

This application claims priority to U.S. Provisional Patent Application, titled “SYSTEM AND METHOD OF TRANSLATING A TRACKING MODULE TO A UNIQUE IDENTIFIER”, filed on May 13, 2022 and accorded Application No. 63/341,646, and claims priority to U.S. Provisional Patent Application, titled “AD SEQUENCES FOR JOURNEY-BASED ADVERTISING”, filed on Nov. 23, 2021 and accorded Application No. 63/264,491, which are incorporated herein by reference

### BACKGROUND

Many users, businesses, and/or other entities provide content items (e.g., images, videos, text, blogs, articles, emails, text messages, links to websites or other content, etc.) to users through various platforms such as search engines, social network platforms, email services, mobile apps, or other content provider services. For example, a sports team may promote an upcoming sporting event through social network posts of images, videos, and/or links to a sporting event ticketing website to purchase tickets. A lawn service may utilize a video sharing platform to display additional content describing the lawn service to users that are watching landscaping videos through the video sharing platform. A videogame console maker may utilize a search engine to display images of an upcoming videogame console being released, along with links to a website through which the videogame console can be preordered. When providing content items to certain users, the content items should be provided in a non-invasive manner and the content items should be relevant to the users. Otherwise, the content items may be irrelevant, annoying, and waste computing resources that were consumed by selecting and transmitting such content items over a network to computing devices of users that will ignore the content items.

### DESCRIPTION OF THE DRAWINGS

Embodiments of the present technology will be described and explained through the use of the accompanying drawings in which:

FIG. 1 is a block diagram illustrating an example of a user interface for generating a content sequence, in accordance with some embodiments.

FIG. 2A-2C are block diagrams illustrating an example of a user interface for generating a campaigns of a content sequence, in accordance with some embodiments.

FIG. 3 is a block diagram illustrating an example of a user interface populated with a content sequence report, in accordance with some embodiments.

FIG. 4 is a flow chart illustrating an example of a set of operations of a method for generating a content sequence, in accordance with some embodiments.

FIG. 5A-5C are block diagrams illustrating an example of implementing a content sequence, in accordance with some embodiments

FIG. 6 is a block diagram illustrating an example of a multi-service business platform, in accordance with some embodiments

The drawings have not necessarily been drawn to scale. Similarly, some components and/or operations may be separated into different blocks or combined into a single block for the purposes of discussion of some embodiments of the present technology. Moreover, while the present technology is amenable to various modifications and alternative forms, specific embodiments have been shown by way of example in the drawings and are described in detail below. The intention, however, is not to limit the present technology to the particular embodiments described. On the contrary, the present technology is intended to cover all modifications, equivalents, and alternatives falling within the scope of the present technology as defined by the appended claims.

### DETAILED DESCRIPTION

Various embodiments of the present technology relate to generating and implementing a content sequence of content items to provide to users. Entities may create and provide users with content items through websites, mobile apps, services, and/or other types of platforms (e.g., a social network platform, a video sharing platform, an image sharing platform, a search engine, etc.). The content items may include images, text, videos, and/or other types of content that may be used to convey information to the users. A substantial amount of computing resources and time may be consumed to create and store the content items within storage resources of computers and servers. Also, network bandwidth and computing resources are consumed when the content items are transmitted over a network from a content item provider service to a client device for display through a user interface. Accordingly, computing resources, network bandwidth, and time are wasted when content items are selected and transmitted to client devices for display to users that will ignore or find the content or subject matter of the content items as irrelevant or annoying. Providing irrelevant content items to users can be interruptive and annoying, thus diminishing the user's experience. Selecting and providing relevant content items whose subject matter may be of interest to certain users is a technical problem that requires a technical solution rooted in computer technology due to the sheer number of content items and users to evaluate (e.g., millions of content items may be available for real-time selection to provide through a platform having millions of users, which is overly burdensome for many computer algorithms to accurately process and impossible for humans to process).

Accordingly, as provided herein, a computer automated technical solution is provided for solving these technical problems by facilitating the generation of a content sequence of select content items and automating the implementation of campaigns that are part of the content sequence in an efficient manner that eliminates the need for manual oversight. This technique automates the process of determining when certain campaigns are to be implemented for showing content items to certain selected users and when those campaigns are to be turned off in order to converse computing resources and budget/costs. Additionally, this technique constructs and utilizes exclusion rules and exclusion lists for determining what users would find certain content items of the campaigns as relevant (e.g., a content item that relates to a problem that the user is trying to solve or relates to an opportunity that the user is seeking) at certain points of time during particular stages of exploring content items through the various stages of the content sequence. This helps entities reach the right users with relevant content items at the right points of times during exploration of the users (e.g., display an introductory content item, then a content item explaining a solution to a problem of the user or an opportunity being sought by the user, and finally a content item showing how the solution or opportunity is best tailored for that user). When the users access a platform (e.g., a social network), a determination is made as to where the user is currently in the content sequence. This, along with the exclusion rules and lists, are used to select the appropriate content item that will best resonate with the user so that computing resources, network bandwidth, time, and budget/cost are not wasted by otherwise providing irrelevant content items to the user that will ignore such content items. In this way, the content sequence can be implemented and controlled in an automated manner using this computer implemented technique in order to engage users through a content exploration journey to deliver contextually relevant content items to users that do not annoy the users, but instead provide the users with information that the users may be seeking, all while staying within budget and on-schedule.

The content sequence may include various stages that utilize different campaigns for selecting certain content items to provide to select users. The content sequence includes a first stage such as an attract stage (corresponding to a user awareness stage) used to attract and build trust with users and/or “break the ice” with users that may have a problem to solve (e.g., a broken vacuum cleaner) and/or may be seeking an opportunity (e.g., seeking an opportunity to invest in real estate rentals). The content sequence includes a second stage such as a convert stage (corresponding to a user consideration stage) used to provide users with information about how their problem can be solved or how the opportunity can be gained. The content sequence includes a third stage such as a closing stage (corresponding to a user decision stage) used to show that a solution to the user's problem and/or the opportunity is the best option for the user such as through case studies, testimonials, user reviews, etc. Each stage may correspond to a campaign used to show one or more content items to users that are currently part of that stage. Interactive user interfaces are provided to guide entities through the creation of content sequences. After creation, this automated technique controls how the campaigns operation, such as when to turn on campaigns, when to turn off campaigns, determining in real-time what audience of users to target or exclude, etc. in order to more efficiently target certain users at certain times with select content items that provide information being sought by the users.

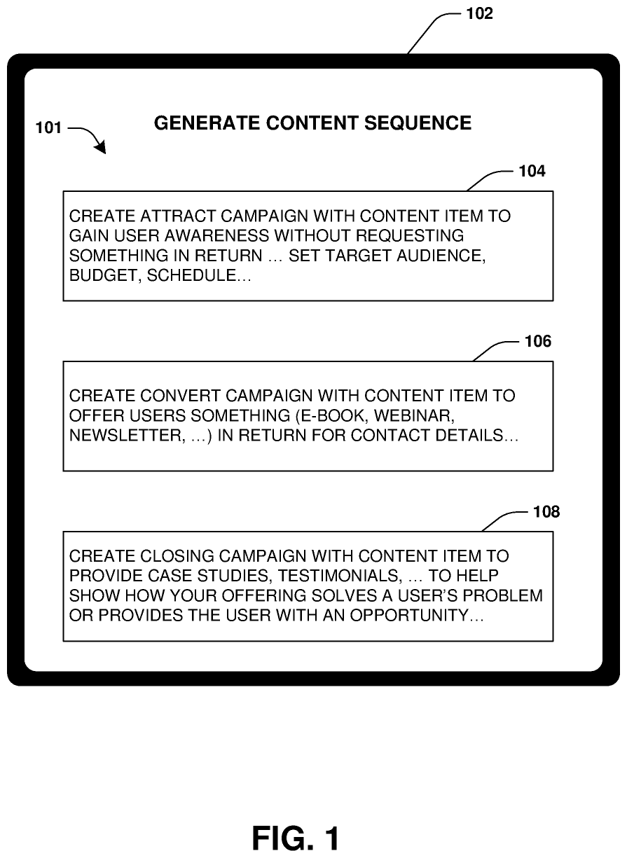

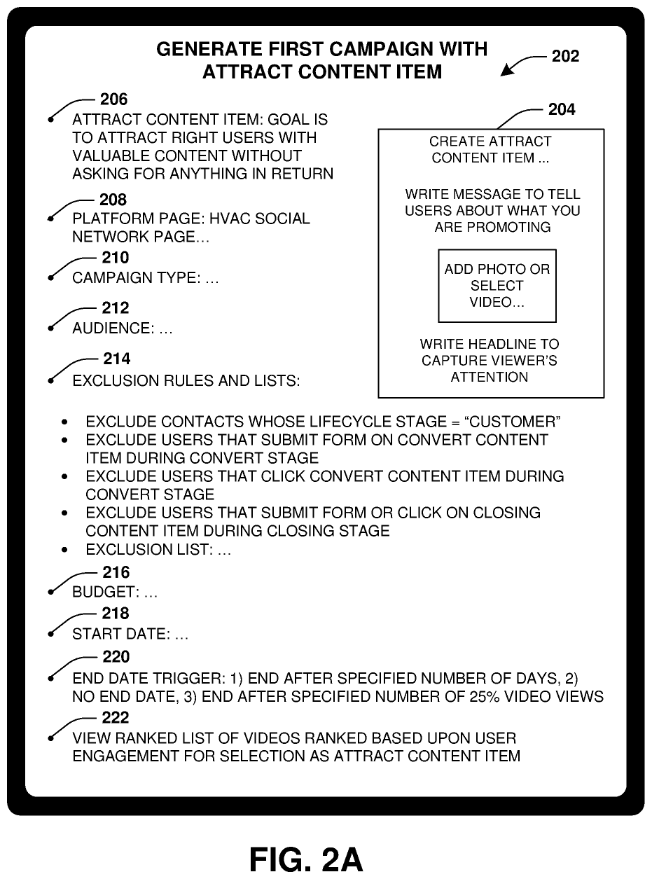

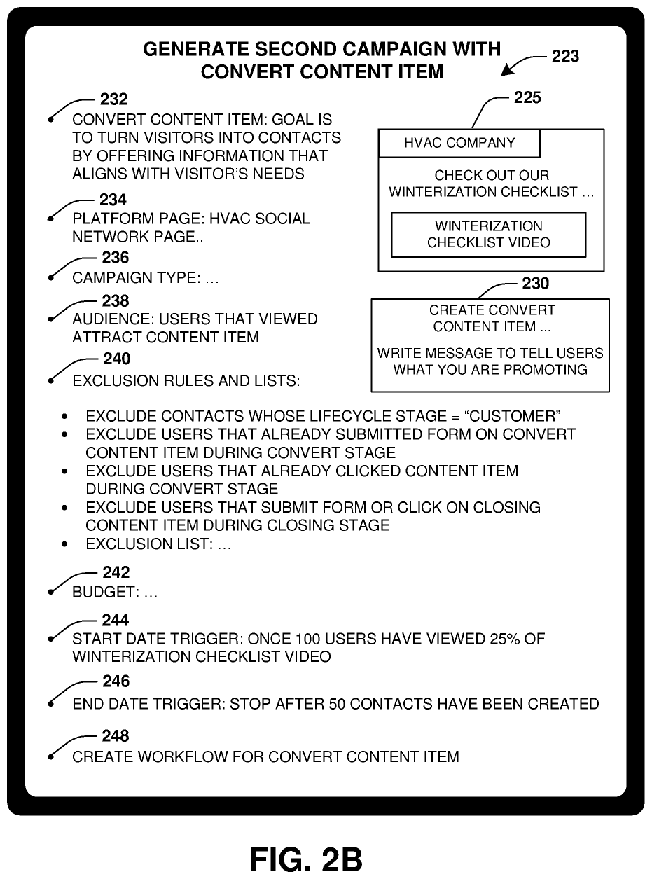

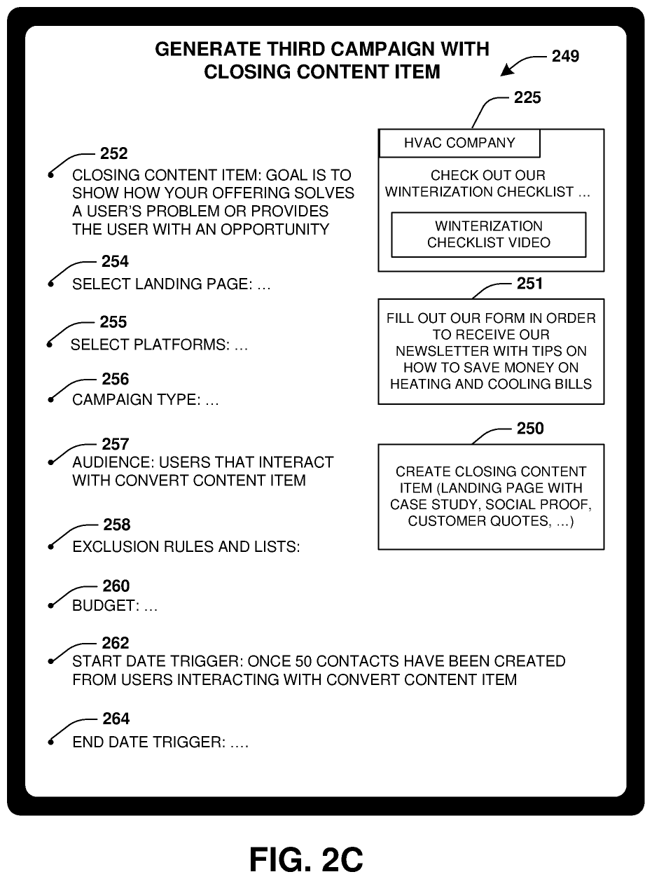

FIG. 1 illustrates a user interface 101 used to guide a user through the creation of a content sequence. The user interface 101 may be displayed on a computing device 102 of the user, such as a laptop, a computer, a mobile device, etc. The user interface 101 may provide a first option 104 to initiate creation of an attract campaign as part of the attract stage of the content sequence. The attract campaign may be created to include one or more content items that can be provided to users in order to gain user awareness without requesting something in return. Further details of creating the attract campaign are further illustrated in relation to FIG. 2A.

The user interface 101 may provide a second option 106 to initiate creation of a convert campaign as part of the convert stage of the content sequence. The convert campaign may be created to include one or more content items that can be provided to users in order to offer the users something (e.g., an e-book, a webinar, a newsletter, etc.) in return for contact details that may be submitted through a form associated with the one or more content items. For example, a user may fill out contact information through a form of a content item in order to receive access to real estate investment tips. Further details of creating the convert campaign are further illustrated in relation to FIG. 2B.

The user interface 101 may provide a third option 108 to initiate creation of a closing campaign as part of the closing stage of the content sequence. The closing campaign may be created to include one or more content items that provide case studies, testimonials, and/or other information to help show how an entity's offering (e.g., a vacuum cleaner repair service, a real estate investment opportunity, etc.) solves the user's problem or provides the user with the opportunity that the user is seeking.

FIG. 2A illustrates a user interface 202 for generating a first campaign of a content sequence, such as the attract campaign. The user interface 202 may be populated with fields through which a user (e.g., an HVAC company) can create the first campaign of the content sequence. The user interface 202 may provide a description 206 of the type of content item that should be included within the first campaign, such as an attract content item with the goal of attracting the right users with valuable content without asking for anything in return, for example. The user interface 202 may be populated with a platform page field 208 through which the user may specify a platform page with which to associate the attract content item of the first campaign (e.g., an HVAC social network page of a social network platform). The user interface 202 may be populated with a campaign type field 210 through which the user may specify a campaign type for the first campaign, such as a post engagement campaign type having a page post engagement objective to drive users to view the platform page (e.g., direct users to the HVAC social network page). In some embodiments, the attract content item may be a content item creative that is an object containing all the data for visually rendering the attract content item itself. In some embodiments, the user interface 202 may provide a recommendation of a type of content item to use as the attract content item, such as a video. The user interface 202 may be populated with an audience field 212 through which the user may specify a target audience for the first campaign. The user may utilize the audience field 212 to create new audiences, select a saved audience, and/or specify whether an audience is to be included or excluded from being shown the attract content item of the first campaign. The user may specify a geographic location, a target lookalike audience (e.g., a group of social network users that share characteristics of another group of social network users), and/or a variety of other demographics or other information used to define an audience (e.g., age, career, gender, etc.).

In some embodiments, the first campaign is associated with a campaign urchin tracking module generated from a globally unique identifier. The first campaign is represented as a campaign object within a customer relationship management (CRM) system. The campaign object is associated registration definition element.

The user interface 202 may generate exclusion rules for excluding certain users that may be tracked within exclusion lists, which may be defined within an exclusion rules and lists field 214. The users within the exclusion list(s) will not be shown the attract content item by the first campaign. A first exclusion rule may be applied to exclude users who are listed as contacts having a lifecycle stage of “customer” indicating that the users are already customers of the HVAC company. A second exclusion rule may be applied to exclude users that have submitted a form through a convert content item of a second campaign during the convert stage of the content sequence (e.g., a user may have filled out contact information through the form in exchange for a newsletter with tips for saving money on heating and cooling bills). The goal of the attract content item of the first campaign is to pique the interest of the user so that when the user subsequently views the convert content item of the second campaign, the user is motivated or has reason to submit contact information through the form of the convert content item. Since these users have already submitted the form through the second campaign, there is no reason to show the attract content item to the users, which saves computing resources, network bandwidth, and budget/cost otherwise wasted in showing the attract content item to these users.

A third exclusion rule may be applied to exclude users that have clicked on the convert content item during the convert stage. Since these users have already interacted with the convert content item of the convert stage that is downstream from the attract stage (e.g., downstream in that the convert content item is to be shown to users only after those users have seen the attract content item), there is no reason to show the attract content item to the users. This saves computing resources, network bandwidth, and budget/cost otherwise wasted in showing the attract content item to these users. A fourth exclusion rule may be applied to exclude users that have submitted a form or clicked on the closing content item of the closing stage. Since these users have already interacted with the closing content item of the closing stage that is downstream from the attract stage and the convert stage, there is no reason to show the attract content item to the users, which saves computing resources, network bandwidth, and budget/cost otherwise wasted in showing the attract content item to these users.

The user interface 202 may be populated with a budget field 216 through which the user may specify a budget for the first campaign, such as a daily budget, a lifetime budget, or some other budget. The user interface 202 may be populated with a start date field 218 through which the user may specify a start date and/or time for the first campaign to start showing the attract content item to users through the platform. The user interface 202 may be populated with an end date trigger field 220 through which the user may specify an end date trigger to end the first campaign so that the attract content item is no longer being displayed to users. The end date trigger field 220 may allow the user to select no end date so that the first campaign runs continuously/indefinitely. The end date trigger field 220 may allow the user to end the first campaign after a certain number of days. The end date trigger field 220 may allow the user to end the first campaign after a certain number of views of the attract content item (e.g., 100 users that have view at least 25% of a video attract content item such as at least 30 seconds of a 1 minute video). The end date trigger field 220 may allow the user to end the first campaign based upon other criteria such as a different audience size being reached, a certain number of clicks of the attract content item occurring, reaching a certain cost per lead, etc. Because the end date of the first campaign may be variable in some instances, a notification may be sent to the HVAC company of when the first campaign is turned off.

The user interface 202 may be populated with a ranked list of videos 222 that the user can select from for creating the attract content item. The ranked list of videos 222 may comprise videos that have been ranked according to user engagement with the videos (e.g., numbers of views, likes, comments, shares, clicks, etc.). The user may also create or upload a different video, image, or other content item to include within the attract content item.

The user interface 202 may be populated with an attract content item creation interface 204 through which the user can create the attract content item. The user may utilize the attract content item creation interface 204 to add images, videos, text, links, and/or other content to create one or more attract content items that the first campaign will use to select and provide to users through the platform such as the social network platform. For example, the user may create an attract content item 225 specifying the HVAC company's name, text “check out our winterization checklist . . . ,” and a winterization checklist video, as illustrated by FIG. 2B.

FIG. 2B illustrates a user interface 223 for generating a second campaign of the content sequence, such as the convert campaign. The user interface 223 may be populated with fields through which the user, such as the HVAC company, can create the second campaign of the content sequence. The user interface 202 may provide a description 232 of the type of content item that should be included within the second campaign, such as a convert content item with the goal of turning visitors into contacts by offering information that aligns with visitor's needs (e.g., a newsletter with tips on how to save money on heating and cooling bills). This information may be provided in exchange for contact information that a user can submit through a form within the convert content item.

The user interface 223 may be populated with a platform page field 234 through which the user may specify a platform page with which to associate the convert content item of the second campaign (e.g., the HVAC social network page of the social network platform). The user interface 223 may be populated with a campaign type field 236 through which the user may specify a campaign type for the second campaign, such as a lead generation campaign type (e.g., a campaign for creating inbound leads for capturing and generating interest in a service or product for the purpose of developing leads) or a website traffic campaign type (e.g., a campaign for driving user traffic to a website such as a website of the HVAC company).

The user interface 223 may be populated with an audience field 238 through which the user may specify a target audience for the second campaign. In some embodiments, the audience field 212 may be auto populated with a target audience of users that have viewed the attract content item 225 (e.g., users that have viewed at least 25% of a video of the attract content item 225; users that liked or shared or commented on the attract content item 225; users that clicked the attract content item 225; etc.). Thus, users that have not viewed the attract content item 225 (e.g., users that have viewed less than 25% of the video attract content item) are excluded from the target audience such that the convert content item of the second campaign will not be shown to those users.

The user interface 223 may generate exclusion rules for excluding certain users that may be tracked within exclusion lists, which may be defined within an exclusion rules and lists field 240. The users within the exclusion list(s) will not be shown the convert content item. A first exclusion rule may be applied to exclude users who are listed as contacts having a lifecycle stage of “customer” indicating that the users are already customers of the HVAC company. A second exclusion rule may be applied to exclude users that have already submitted a form through the convert content item of the second campaign during the convert stage of the content sequence (e.g., a user may have already filled out contact information through the form in exchange for a newsletter with tips for saving money on heating and cooling bills). Since these users have already submitted the form through the convert content item, there is no reason to show the convert content item again, which saves computing resources, network bandwidth, and budget/cost otherwise wasted in showing the convert content item to these users again even though contact information has already been submitted and collected for the closing stage of the content sequence.

A third exclusion rule may be applied to exclude users that have clicked on the convert content item during the convert stage. Since these users have already interacted with the convert content item of the convert stage, there is no reason to show the convert content item again, which saves computing resources, network bandwidth, and budget/cost otherwise wasted in showing the convert content item to these users again. A fourth exclusion rule may be applied to exclude users that have submitted a form or clicked on the closing content item of the closing stage. Since these users have already interacted with the closing content item of the closing stage that is downstream from the convert stage, there is no reason to show the convert content item to the users, which saves computing resources, network bandwidth, and budget/cost otherwise wasted in showing the convert content item to these users.

The user interface 223 may be populated with a budget field 242 through which the user may specify a budget for the second campaign, such as a daily budget, a lifetime budget, or some other budget. The user interface 223 may be populated with a start date trigger field 244 through which the user may specify a start date and/or time for the second campaign to start showing the convert content item to users through the platform. In some embodiments, the start of the second campaign may be based upon a number of users that viewed or interacted with the attract content item 225. In some embodiments, a suggested start trigger for the second campaign may be programmatically determined and auto populated within the start date trigger field 244 (e.g., the second campaign will be triggered to start once 2,000 users have viewed at least 25% of the attract content item 225). The suggested start trigger may be based upon an audience size from the first campaign that will result in a cost efficient second campaign. If the audience size is too small, then a lot of computing resources and budget/cost will be wasted in trying to reach such as small audience. The audience size may be programmatically determined using various heuristics, machine learning, and/or other algorithms that evaluate prior campaign data and audience data. This may also take into consideration the rate of new users viewing or interacting from the first campaign to the second campaign so that the second campaign is initiated/started once the first campaign starts to taper off (e.g., the rate of new users viewing or interacting with the attract content item 225 falls below a threshold value such as less than 1 user per day or any other threshold, and thus the first campaign is ended and the second campaign is started). Because the start date of the second campaign may be variable based upon the first campaign, a notification may be sent to the HVAC company of when the second campaign is triggered.

The user interface 223 may be populated with an end date trigger field 246 through which the user may specify an end date trigger to end the second campaign so that the convert content item is no longer being displayed to users. In some embodiments, the end date trigger field 220 may allow the user to end the second campaign after a certain number of contacts have been created through users filling out the form of the attract content item 225 with contact information (e.g., the second campaign ends after 50 contacts have been created). Because the end date of the second campaign may be variable based upon the number of contacts being created, a notification may be sent to the HVAC company of when the second campaign is turned off.

The user interface 223 may be populated with a workflow creation field 248. The workflow creation field 248 allows users to define and/or select custom tailored workflows that are triggered based upon certain interactions with the convert content item (e.g., a user clicking on the convert content item, the user viewing the convert content item, the user filling out the form with contact details, etc.). The workflows may correspond to computer implemented actions that are programmatically performed by a computer, such as sending an email to a particular email contact (e.g., sending an email notification to an email address of a scheduling employee of the HVAC company for reaching out to the user to schedule an appointment), a text message notification, adding the user to a contact list, generating an in-app notification to display a notification through an application (e.g., generating an alert that contact information was received), assigning a task to a person (e.g., automatically populating a calendar entry within an electronic calendar of the scheduling employee), creating a record of task to be performed (e.g., programmatically generating a task within a computer task interface indicating that an HVAC maintenance task is to be performed), etc. The workflows may be defined with custom code, data formatted according to certain data formats, if/then branches (e.g., if a certain interaction with the convert content item has occurred and the user is located in a particular city, then a particular action will be performed such as sending an electronic message to an HVAC service center in that city), value equals braches (e.g., if user location=Cleveland, then send message to HVAC employee located in Cleveland to reach out to user), and/or other logic functions for determining what actions the workflow is to perform based upon various criteria such as how the user interacted with the convert content item and/or what information about the user is available (e.g., did the user request an appointment, did the user request certain types of HVAC advice such as money saving tips, did the user express an interest in purchasing certain equipment, which service center is closest to a current location of the user so that a notification is routed to that service center, etc.).

The user interface 223 may be populated with a convert content item creation interface 230 through which the user can create the convert content item. The user the utilize the convert content item creation interface 230 to add images, videos, text, links, and/or other content to create one or more convert content items that the second campaign will use to select and provide to users through the platform such as the social network platform. The convert content item creation interface 230 may provide a template form that can be selected and/or modified by the user for inclusion within the convert content item as a form that a user viewing the convert content item can fill out in order to submit contact information (e.g., a form with a name field, an email address field, a phone number field, an address field, etc.). The convert content item creation interface 230 may provide a suggestion of content to offer users in response to the users filling out the form or may provide an interface element that the user can utilize the designate what content would be offered to users. For example, the user may create an convert content item 251 that includes text and a form that users can fill out with contact information in order to sign up for a newsletter, as illustrated by FIG. 2C. In some embodiments, a workflow may be associated with the second campaign such that when users fill out the form of the convert content item 251, the newsletter is automatically sent to an email address or mailing address specified through the form, which may also be added to a future mailing list of the newsletter for subsequent mailings.

FIG. 2C illustrates a user interface 249 for generating a third campaign of the content sequence, such as the closing campaign. The user interface 249 may be populated with fields through which the user, such as the HVAC company, can create the third campaign of the content sequence. The user interface 249 may provide a description 252 of the type of content item that should be included within the third campaign, such as a closing content item with the goal of showing how the HVAC company offers a solution to a problem or provides an opportunity being sought by users.

The user interface 249 may be populated with a landing page selection field 254 through which the user may specify a landing page to which the closing content item will redirect a user interacting with the closing content item. For example, the landing page may be specified as a link to an HVAC website of the HVAC company. In this way, a link to the landing page may be embedded within the closing content item such that a user will be redirected to the landing page by the link when the user interacts with the closing content item.

The third campaign may be associated with one or more platforms (e.g., additional platforms other than the social network platform used by the first campaign and the second campaign) for providing users with the closing content item. Accordingly, the user interface 249 is populated with a platform selection field 255 through which the user may select or specify platforms that are to be used by the third campaign for displaying the closing content item to users of those platforms (e.g., a search engine platform, a website, an email platform, a video sharing platform, etc.).

The user interface 249 may be populated with a campaign type field 256 through which the user may specify a campaign type for the third campaign, such as the website traffic campaign type (e.g., a campaign for driving user traffic to the HVAC website of the HVAC company).

The user interface 249 may be populated with an audience field 257 through which the user may specify a target audience for the third campaign. In some embodiments, the audience field 257 may be auto populated with a target audience of users that have interacted with the convert content item 251 (e.g., users that have clicked the convert content item 251 and/or filled out the form of the convert content item 251). Thus, users that have not viewed the attract content item 225 (e.g., users that have viewed less than 25% of the video attract content item) and/or users that have not interacted with the convert content item 251 are excluded from the target audience such that the closing content item of the third campaign will not be shown to those users. This ensures that the closing content item is relevant to users that are provided with the closing content item because the attract content item and/or the convert content item built up rapport and trust with these users.

The user interface 249 may generate exclusion rules for excluding certain users that may be tracked within exclusion lists, which may be defined within an exclusion rules and lists field 258. The users within the exclusion list(s) will not be shown the closing content item. A first exclusion rule may be applied to exclude users who are listed as contacts having a lifecycle stage of “customer” indicating that the users are already customers of the HVAC company. A second exclusion rule may be applied to exclude users that have already interacted with the closing content item or have interacted with or ignored the closing content item a threshold number of times.

The user interface 249 may be populated with a budget field 260 through which the user may specify a budget for the third campaign, such as a daily budget, a lifetime budget, or some other budget. The user interface 249 may be populated with a start date trigger field 262 through which the user may specify a start date and/or time for the third campaign to start showing the closing content item to users through the one or more platforms. In some embodiments, the start of the third campaign may be based upon a number of contacts created from users filling out the form of the convert content item 251. In some embodiments, a suggested start trigger for the second campaign may be programmatically determined and auto populated within the start date trigger field 262 (e.g., the third campaign will be triggered to start once 50 contacts have been created through the second campaign). The suggested start date trigger may be based upon a contact list size that results in a cost effective third campaign. If the contact list size is too small, then a lot of computing resources and budget/cost will be wasted in trying to reach such as small pool of users. The audience size may be programmatically determined using various heuristics, machine learning, and/or other algorithms that evaluate prior campaign data and audience data. This may also take into consideration the rate of new contacts being created by the second campaign so that the third campaign is initiated/started once the second campaign starts to taper off (e.g., the rate of new contacts being created falls below a threshold value such as less than 1 contact per week or any other threshold, and thus the second campaign is turned off and the third campaign is turned on). Because the start date of the third campaign may be variable based upon the second campaign, a notification may be sent to the HVAC company of when the third campaign is triggered. The user interface 249 may be populated with an end date trigger field 264 through which the user may specify an end date trigger to end the third campaign so that the closing content item is no longer being displayed to users (e.g., once a certain number of customers have been created by the third campaign; after a certain number of days of running the third campaign; etc.).

The user interface 249 may be populated with a closing content item creation interface 250 through which the user can create the closing content item. The user the utilize the closing content item creation interface 250 to add images, videos, text, links, and/or other content to create one or more closing content items that the third campaign will use to select and provide to users through the one or more platforms specified through the platform selection field 255. The closing content item creation interface 250 may provide a suggestion to include case studies, social proof, customer quotes, a link to the landing page specified through the landing page selection field 254, and/or other information for inclusion within a closing content item.

Once the first campaign, the second campaign, and the third campaign are created, the campaigns are programmatically turned on and off in an automated manner without manual user intervention or control based upon the start date triggers and the end date triggers. The triggers are identified based upon tracking metrics collected in real-time based upon users viewing and/or interacting with content items provided by the campaigns to the users through the one or more platforms associated with the campaigns. A particular user's journey with respect to exploring the content items through the campaigns is tracked to ensure that once a user has viewed or interacted with a content item of one campaign, then that user is excluded from being provided with certain content items (e.g., the same content item again or other content items of upstream campaigns).

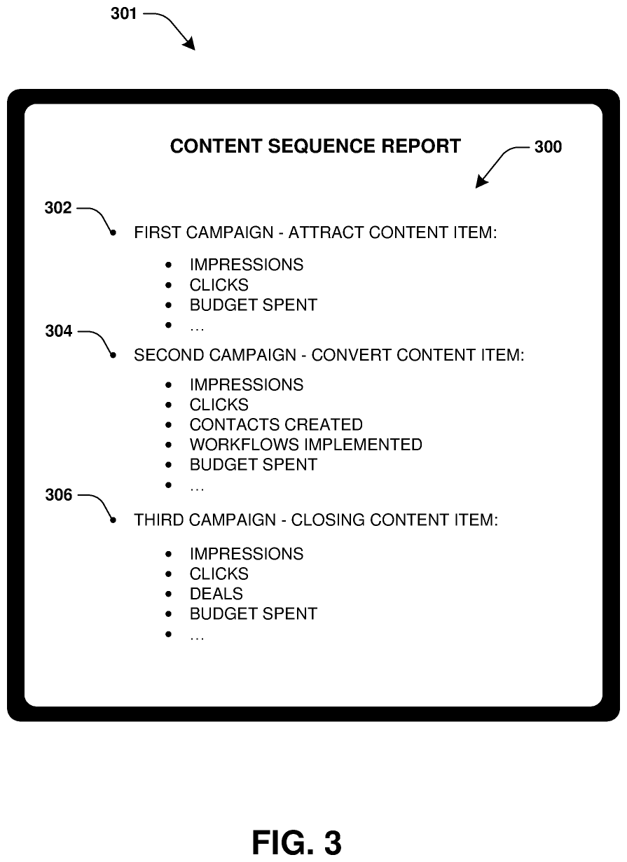

FIG. 3 illustrates a computing device 301 displaying a user interface 300 populated with a content sequence report for a content sequence. The content sequence may include a first campaign that provides one or more attract content items to users of a platform. The content sequence may include a second campaign that provides one or more convert content items to users of the platform. The content sequence may include a third campaign that provides one or more closing content items to users of the platform and/or other platforms. It may be appreciated that the content sequence may include any number of campaigns (e.g., 2 campaigns, 4 campaigns, etc.), and that 3 campaigns is used herein as one embodiment of a content sequence. Also, any of the campaigns may be associated with any number of platforms. Various metrics may be tracked while the campaigns of the content sequence are active. For example, the number of impressions, clicks, budget spent, and/or other metrics 302 for the first campaign serving an attract content item may be tracked and populated within the content sequence report. The number of impressions, clicks, contacts created (e.g., contacts created through a form of a convert content item), workflows implemented (e.g., a workflow of sending an email to a particular email address based upon a user filling out the form of the convert content item), budget spent, and/or other metrics 304 for the second campaign serving the convert content item may be tracked and populated within the content sequence report. The number of impressions, clicks, deals (e.g., a user becoming a customer such as by signing up for a service or purchasing a product), and/or other metrics 306 for the third campaign serving a closing content item may be tracked and populated within the content sequence report. The content sequence report may also be populated with other information such as a number of customers, a number of contacts, a cost per contact, a cost per customer, a return on investment, etc.

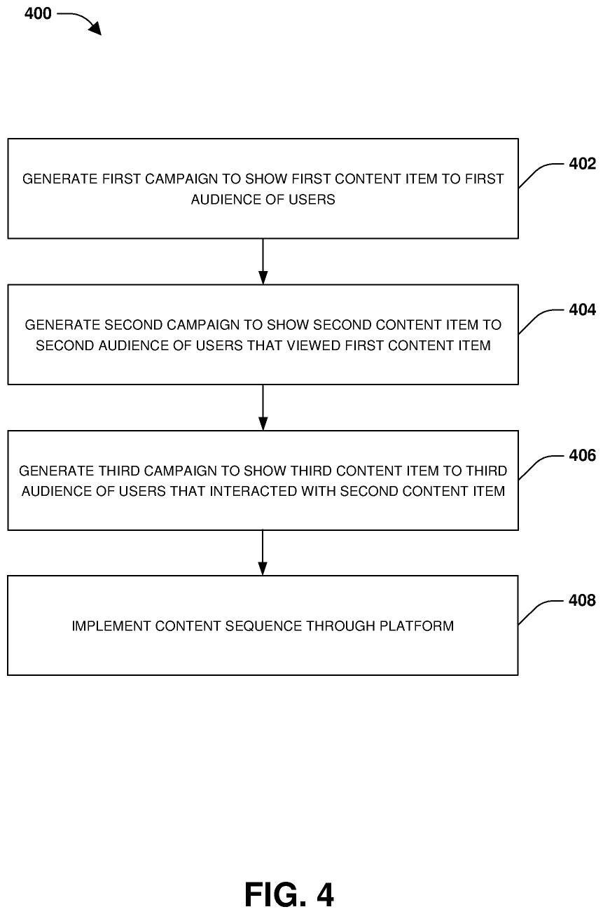

A method 400 for generating and implementing a content sequence is illustrated by FIG. 4. During operation 402 of method 400, a first campaign of the content sequence is generated for a user (e.g., a pool cleaning company) to include a first content item to display to a first audience of users of a platform (e.g., a video about the pool cleaning company providing pool cleaning tips, which can be played for users of a social network platform). In some embodiments, the user may be provided with a ranked list of videos for selection as the first content item. The ranked list of videos may include videos of the pool cleaning company that are ranked based upon prior user engagement with the videos (e.g., likes, comments, shares, views, clicks, etc.). During operation 404 of method 400, a second campaign of the content sequence is generated to include a second content item (e.g., content that includes text, an image, a video, a form through which a user may submit contact information, and/or other information) to display to a second audience of the users of the platform. The second audience may be constrained to users that viewed the first content item, and thus the second content item is restricted from being displayed to users that did not yet view the first content item. During operation 406 of method 400, a third campaign of the content sequence is generated to include a third content item (e.g., content that includes text, an image, a link to a landing page, and/or other information) to display to a third audience of users of one or more platforms (e.g., a search engine, a website, through an application, etc.). The third audience may be constrained to users that viewed or interacted with the second content item (e.g., filled out the form or clicked the second content item), and thus the third content item is restricted from being displayed to users that did not yet view or interact with the second content item. Submission of the form may be used to create a contact list of users defined and tracked as the third audience.

Exclusion rules and exclusion lists may be generated and applied to the campaigns in order to exclude certain users from target audiences of the campaigns. An exclusion rule may be implemented to generate an exclusion list to exclude users from being provided with the first content item by the first campaign, the second content item by the second campaign, and/or the third content item by the third campaign based upon the user being tracked as having a “customer” lifecycle status with respect to the pool cleaning company (e.g., users that are already customers of the pool cleaning company). An exclusion rule may be implemented to generate an exclusion list to exclude users from being provided with the first content item by the first campaign based upon the users submitting the form associated with the second content item. An exclusion rule may be implemented to generate an exclusion list to exclude users from being provided with the first content item by the first campaign based upon the users interacting with, such as clicking, the second content item. An exclusion rule may be implemented to generate an exclusion list to exclude users from being provided with the first content item and the second content item based upon the users interacting with the third content item. An exclusion rule may be implemented to generate an exclusion list to exclude users from being provided with the second content item by the second campaign based upon the user already interacting with the second content item such as by filling out the form with contact information. As users view and/or interact with content items of the campaigns, the exclusion lists may be dynamically updated in real-time and automatically applied to the campaigns.

During operation 408 of the method 400, the content sequence may be automatically implemented and controlled through computer implemented functionality without little to no manual user intervention. Campaigns may be turned on and turned off based upon various start date triggers and end date triggers. The first campaign may be turned off based upon a determination that a threshold number of users have viewed the first content item (e.g., viewed at least a certain percentage of a video, such as at least 50% (30 seconds) of a 1 minute video). The second campaign may be turned on based upon a threshold number of users viewing the first content item (e.g., at least 300 users viewing at least 30 seconds of the 1 minute video). A notification may be sent to the user (e.g., the pool cleaning company as an owner of the content sequence) that the second campaign has started. If a user interacts with the second content item, then a workflow defined for the second campaign may be triggered (e.g., an introduction email may be generated and sent to an email address of the user). A notification may be sent to the user that the second campaign has ended based upon an end criteria being met (e.g., 500 contacts being created from users submitting contact information through the form of the second content item). Because the third campaign may be associated with multiple platforms, the third content item may be provided to users through the multiple platforms such as concurrently for improved efficiency. The third campaign may be turned on based upon a threshold number of users submitting the form associated with the second content item. Notifications of the third campaign starting and ending may be provided to the user. A report may be generated to indicate a first number of users that viewed or interacted with the first content item, a second number of users that viewed or interacted with the second content item, a third number of users that viewed or interacted with the third content item, and/or other information such as a number of contacts created, a number of customers created through the content sequence, etc.

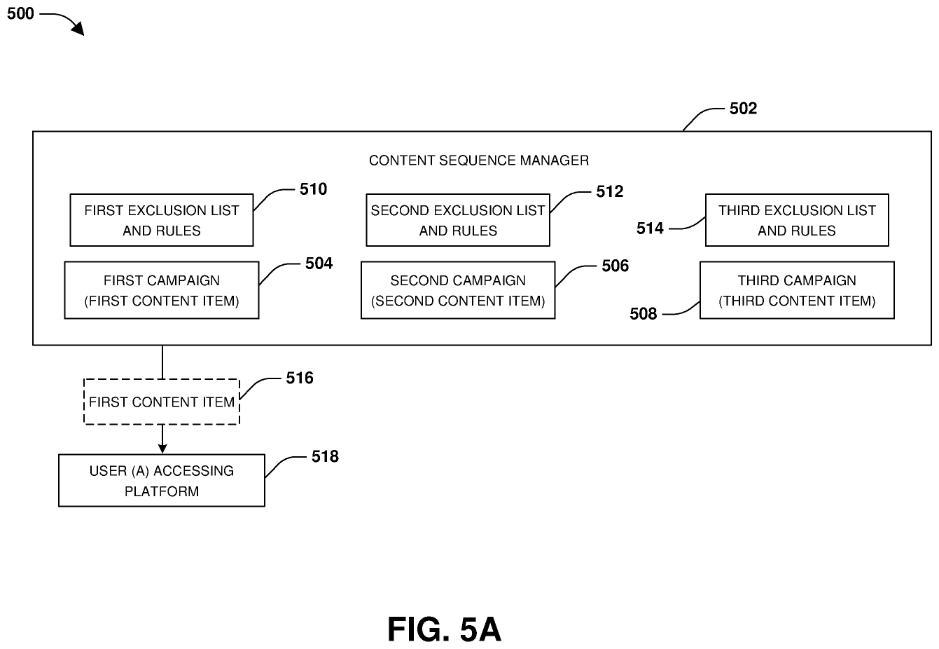

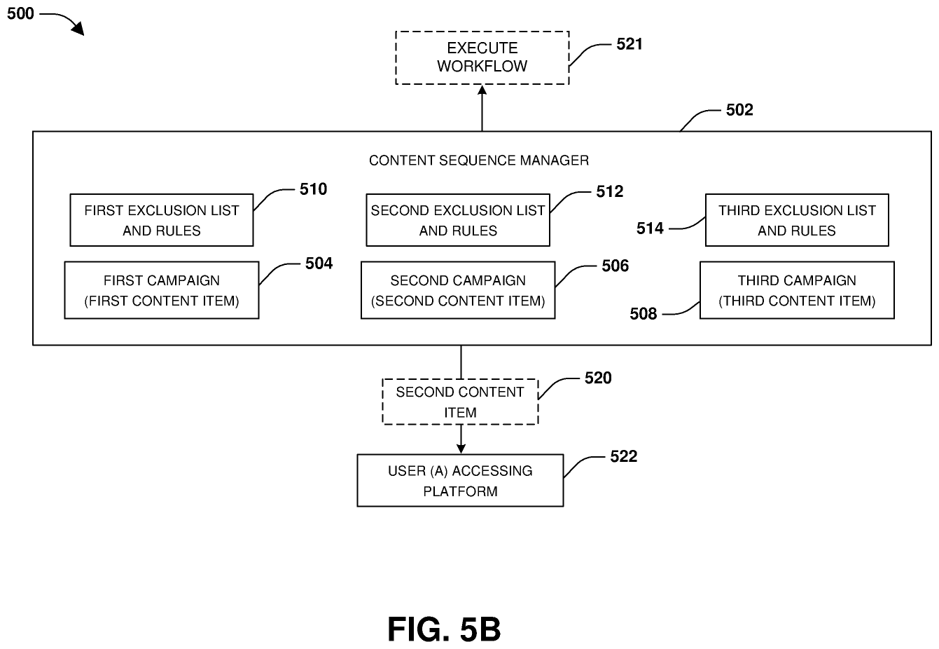

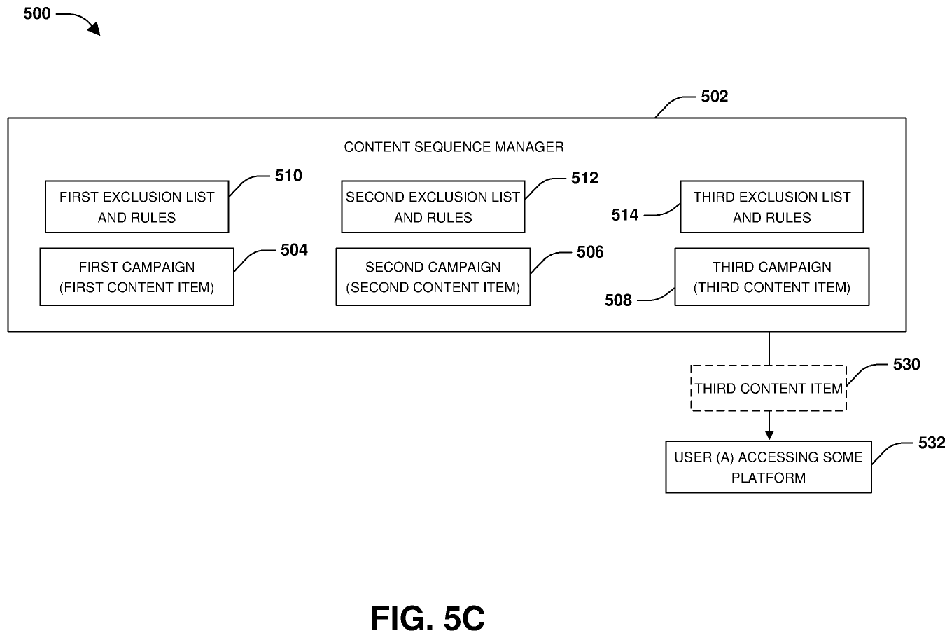

FIGS. 5A-5C illustrate an example of a system 500 for implementing a content sequence. A content sequence manager 502 may be hosted on a computer utilizing hardware and/or software of the computer for generating and/or implementing the content sequence in a computer automated manner. The content sequence includes a first campaign 504 with a first content item 516, a second campaign 506 with a second content item 520, and a third campaign 508 with a third content item 530. A first exclusion list and rules 510 are applied to the first campaign 504 for determining which users to target and which users to exclude from being provided with the first content item 516 of the first campaign 504. A second exclusion list and rules 512 are applied to the second campaign 506 for determining which users to target and which users to exclude from being provided with the second content item 520 of the second campaign 506. A third exclusion list and rules 514 are applied to the third campaign 508 for determining which users to target and which users to exclude from being provided with the third content item 530 of the third campaign 508.

In response to a user (A) accessing 518 a platform (e.g., the user (A) browsing a social network through a social network application) through which the first campaign 504 is being implemented, the first exclusion list and rules 510 are used to determine whether the user (A) is eligible to be provided with the first content item 516 or is to be excluded from the first campaign 504, as illustrated by FIG. 5A. If the user (A) is eligible, then the first content item 516 may be displayed through the social network application to the user (A). Tracking information may be generated and/or updated to indicate that the user (A) has now viewed the first content item 516. The tracking information may be used to update the first exclusion list and rules 510 (e.g., the exclude the user (A) from being re-shown the first content item 516), the second exclusion list and rules 512 (e.g., to indicate that the user (A) is now eligible to be shown the second content item 520), and/or the third exclusion list and rules 514. The tracking information may also be used to update information used to determine whether any of the campaigns are to start or end (e.g., a count of users that have viewed the first content item 516 may be updated for comparison with a threshold to see if the second campaign 506 is to be started; a count of users that have viewed the first content item 516 may be updated for comparison with a threshold to see if the first campaign 504 is to be stopped; etc.).

In response to the user (A) subsequently accessing 522 the platform through which the second campaign 506 is being implemented (e.g., after the start of the second campaign 506 has been triggered), the second exclusion list and rules 512 are used to determine whether the user (A) is eligible to be provided with the second content item 520 or is to be excluded from the second campaign 506, as illustrated by FIG. 5B. If the user (A) is eligible, then the second content item 520 may be displayed through the social network application to the user (A). The user (A) may submit contact information through a form of the second content item 520. Tracking information may be generated and/or updated to indicate that the user (A) has now submitted the form of the second content item 520. The tracking information may be used to update the first exclusion list and rules 510, the second exclusion list and rules 512 (e.g., to exclude the user (A) from being re-shown the second content item 520), and/or the third exclusion list and rules 514 (e.g., to indicated that the user (A) is now eligible to be shown the third content item 530). The tracking information may also be used to update information used to determine whether any of the campaigns are to start or end (e.g., a count of users that have submitted the form may be updated for comparison with a first threshold to determine if the third campaign 508 is to be started and/or for comparison with a second threshold to determine if the second campaign 506 is to be stopped). Execution of a workflow 521 defined for the second campaign 506 may be triggered based upon the user (A) submitting the form (e.g., a user account may be created for the user (A) and the user account information may be sent to an email address provided by the user (A) through the form; a newsletter may be sent to the email address; access to a feature of an application or service may be unlocked for the user (A); access to a video may be provided to the user (A); etc.).

In response to the user (A) subsequently accessing 532 a platform (e.g., the social network platform or a different platform such as a search engine website, an email application, a video sharing website, etc.) through which the third campaign 508 is being implemented (e.g., after the start of the third campaign 508 has been triggered), the third exclusion list and rules 514 are used to determine whether the user (A) is eligible to be provided with the third content item 530 or is to be excluded from the third campaign 508, as illustrated by FIG. 5C. If the user (A) is eligible, then the third content item 530 may be provided to the user (A). The user (A) may view and/or interact with the third content item 530. Tracking information may be generated and/or updated to indicate that the user (A) has now viewed and/or interacted with the third content item 530. The tracking information may be used to update the first exclusion list and rules 510, the second exclusion list and rules 512, and/or the third exclusion list and rules 514. The tracking information may also be used to update information used to determine whether any of the campaigns are to start or end (e.g., a count of users that have interacted with the third content item 530 may be compared with a threshold to determine if the third campaign 508 is to be stopped).

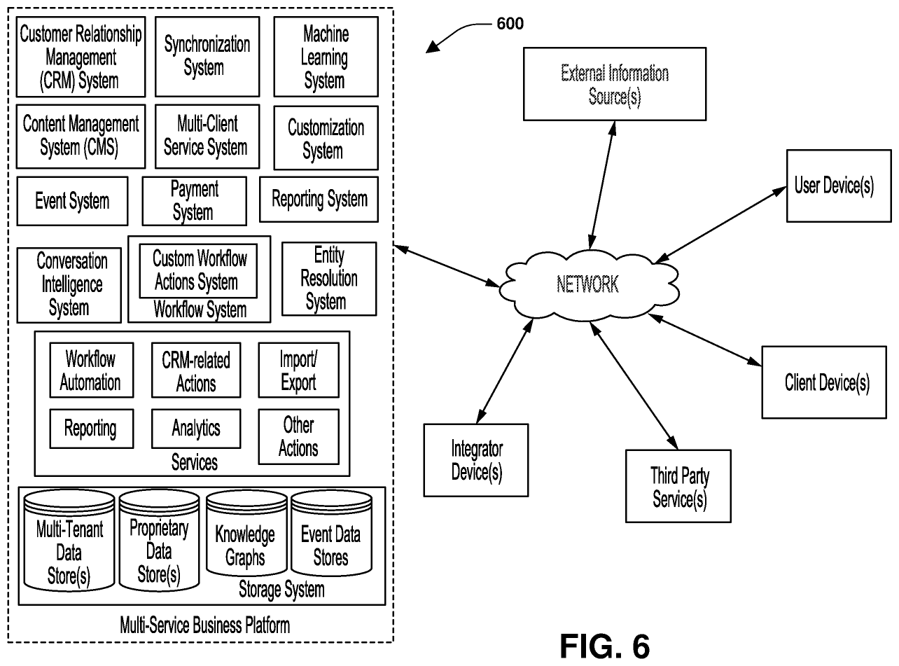

FIG. 6 is a block diagram illustrating an example of a multi-service business platform 600 the includes a customer relationship management (CRM) system, a synchronization system, a machine learning system, a content management system (CMS), a multi-client service system, a customization system, an event system, a payment system, a reporting system, a conversation intelligence system, a custom workflow actions system, a workflow system, an entity resolution system, services (e.g., workflow automation, reporting, CRM-related actions, analytics, import/export, and other actions), and a multi-service business platform (e.g., multi-tenant data stores, proprietary data stores, knowledge graphs, and event data stores), which are further described in U.S. Provisional Patent Application, titled “SYSTEM AND METHOD OF TRANSLATING A TRACKING MODULE TO A UNIQUE IDENTIFIER”, filed on May 13, 2022, which is incorporated herein by reference. The multi-service business platform 600 may communicate with various devices, services, and information sources over a network.

The embodiments described herein may be focused toward systems and/or processes for translating between urchin tracking module (UTM) content, such as may be used in a uniform resource locator (URL) of an advertising campaign and a globally unique identifier (GUID) that may be used to uniquely identify a database object, such as a database object for an advertising campaign and the like. In embodiments, a campaign urchin tracking module (UTM) to globally unique identifier (GUID) and validation system may embody systems and/or processes that may tie to a multi-service business platform framework, thereby allowing services of the campaign UTM to GUID and validation system to access campaign data that may be integrated into the platform framework (e.g., centralized data framework, distributed data framework, and the like). Acentral facet for an exemplary marketing hub product may include being able to report on effectiveness of a campaign (e.g., a marketing campaign and the like). In example embodiments, assigning a universal ID to each campaign may facilitate integral workings of such a product. This may allow for reporting on any or all aspects of the campaign and tying customer business activity back to that campaign (e.g., tying a customer's journey through various business activities back to a campaign may provide a holistic overview of how a business cycle is actually functioning). Further, aspects of a campaign UTM to GUID and validation system may be different and unique by having access to an entire office suite of activities and then being able to map that out from a marketing campaign. Compared to existing UTM solutions, these systems and/or processes may be based on a combination of converting a UTM to a GUID and then using the GUID to connect to the multi-service business platform in a universal object access framework.

Business enterprises, individuals, and the like may employ digital marketing campaigns for, among other things, promotional purposes, such as to achieve awareness of a new product or service. Tracking activity and results of these digital marketing campaigns may rely on a mechanism of passing information among computing instances/systems via an Internet Protocol, such as a universal record locator (e.g., URL). In particular, a mechanism referred to as UTM, which is known to stand for Urchin Tracking Module may provide valuable information to digital marketing campaigns. A UTM, which may be passed as a set of parameterized fields in a URL, may include among other things an identifier for a corresponding digital marketing campaign. In example embodiments, an identifier for a digital marketing campaign may be represented in a UTM as a value of a “utm_campaign” field. When the “utm_campaign” field, herein referred to as the campaign name may be unique for a given digital campaign tracking framework, all activity associated with URLs containing a corresponding UTM may be tracked and attributed to the corresponding digital marketing campaign.

Digital marketing campaigns may include a range of digital assets, such as advertisements, posts (e.g., blog posts, social media posts), emails, webpages, workflows, and the like. A digital marketing framework may handle these assets through a structured database, such as a customer relationship management (CRM) database that may be configured to relate this range of assets to a campaign based on, for example, the unique campaign name. When the amount of data handled by such a framework is small, a unified database may suffice for economical operation. However, generally and in example embodiments, the amount of data (e.g., the number of campaigns, number of assets, number of distinct clients with campaigns, and the like) may far exceed capabilities for even a database distributed over a few data servers. Therefore, campaign databases, and without limitation CRM databases used for handling such campaigns may be distributed over dozens if not hundreds or more of servers across the Internet. Further, as the number of campaigns and the number of clients executing campaigns handled by a distributed CRM database increase, it may become likely that two or more campaigns may be assigned the same human readable name. Resolving a UTM with a campaign name that is not uniquely distinguishable for a given distributed CRM database (or the like) may require significant computing resources (and more importantly excessive time) that may likely compromise the campaign at best and may result in failure at worst.

In some examples, even without a campaign name collision as noted in the disclosure, determining a location of content (e.g., a database object instance of a campaign) for a particular UTM in a large distributed database may involve undue overhead in terms of computing resources (e.g., maintaining and accessing cross references of campaign-location with a human assigned campaign name across many servers for each occurrence of a UTM in an advertising campaign), excessive time (delays due to processing a URL may result in user dissatisfaction), as well as impacting handling common occurrences, such as a change to a human-assigned campaign name (e.g., updating such cross reference resources throughout the distributed database and maintaining a history of object instances of prior campaign names and related data).

In example embodiments, large distributed databases, among other types of record keeping systems, may benefit from efficient assignment of a unique identifier to each item in such a database. In example embodiments, for a database as referenced herein for use with digital advertising methods and systems, a unique identifier may be assigned to a set of records (e.g., a database object instance) for each campaign in the database. Various approaches for generating a statistically unique identifier in some examples may be embodied in the disclosure. In an example, one such approach may involve producing a long random number so that even if more than one billion such numbers are generated, a probability of a collision may be well below a collision threshold for use of the identifiers generated. Example embodiments of such a statistically unique identifier may be referred to herein as, among other things a GUID, which may be an acronym for “Globally Unique Identification Data”, “Globally Unique Identifier”, unique object identifier, unique object ID, ID, and/or the like in the disclosure and figures depicted herein. Further, a human assigned/generated campaign name may be abbreviated herein as HGCN.

A need for efficient methods and systems to ensure that each campaign name—for at least a digital advertising framework—that may be used in an UTM may be unique. A need for unique campaign naming methods and systems that may enable users to define (and redefine) a human-readable name for each campaign without being artificially restricted to a subset of all possible names, such as only using names that may not already be in use by another customer in a multi-service business platform database. Also, there may be a need for efficient access to a corresponding portion of a distributed CRM database (e.g., a database object instance) when presented with a unique campaign name. In example embodiments, a Campaign Urchin Tracking Module (UTM) may be a global standard used by marketers to track effectiveness of marketing campaigns across different sources and media (e.g., identifying marketing campaign clicks and internet activity). A campaign UTM may be a standard way of linking a marketing campaign to a location of clicks. A campaign UTM may be defined to facilitate linking user activity to the campaign. In example embodiments, clicking on an ad, may take you to a company webpage. The corresponding URL on a browser's address bar likely may have a relatively long string of words, characters, numbers, symbols, and the like that may be tagged onto a link, so that when a browser arrives at the target website, it may obtain insights and/or analysis such as a click coming from social network or a click coming from an ad, and these actions may be associated with a marketing campaign. A campaign UTM may be a standard way of expressing the notion that clicks came from the marketing campaign. Campaign UTMs may be a marketing industry wide concept.

In embodiments, a globally unique identifier (GUID) may be a randomly generated identifier with a relatively low probability of collision which may be commonly used as an identifier in distributed systems. In example embodiments, described herein are systems and processes of a way to directly translate a campaign UTM into a GUID. As noted in the disclosure, a GUID may be essentially a relatively long, random number that may be generated in a specific way. A valuable property of a GUID may be the ability to randomly generate them. Even if a system may generate billions of GUIDs, the probability of getting a collision may be extremely low. This means that GUIDs may be used by distributed systems, such as systems with a relatively large data set that may not easily fit on a single database server. To operate effectively, the data set may be split across one hundred or more servers. The system may use each GUID as the unique ID for existing and new entries knowing that the system may likely not get a collision between two entries in the data set having same GUID.

Distributed systems may be used for advertising campaigns and the like by companies that have data sets that may be relatively large (e.g., the data set may not fit on one computer, may not fit on a local database, may not fit on one system, etc.). In example embodiments, accessing a distributed system with a UTM may require a two-step process: (i) the system checks the UTM and (ii) looks up and determines which object belongs in the data set for the UTM. In example embodiments, this may involve using a cross reference between a campaign identification portion of the UTM and an identifier of the corresponding object in the distributed data set. As an example embodiment, the system may obtain the location of the resource (e.g., blog post) in the data set through the two step process, and then may use that resource to execute one or more activities that may be required in the campaign. Therefore, when translating a UTM to an object identifier/location, an extra data store query may be introduced to lookup the location. The methods and systems of UTM to GUID processing described in the disclosure may be able to directly convert a UTM to an object location (e.g., GUID), which may allow for performance improvements in distributed systems. In example embodiments, a system to transform a UTM directly to a GUID may enable the system to query a correct data store or an intermediary system in between, and may provide faster access to data set assets even for systems with externally distributed databases.

A multi-service business platform may include a campaign urchin tracking module (UTM) to globally unique identifier (GUID) and validation system for enabling efficient and disambiguated access to a campaign object in a database, such as a customer relationship management (CRM) database based on an encrypted string in a UTM property of a uniform resource locator (URL). The multi-service business platform may also include a registration system of registration patterns that enable independence of applications that consume CRM object data from the underlying structures of those objects while further enabling efficiently maintaining consistency and updating of objects. The campaign UTM to GUID and validation system and the registration system may communicate with various systems of the multi-service business platform.

A system of the multi-service business platform may include a registration system (that may include a registration definition service) connected to a storage system and to a customization system (that may include a registration definition service) via a set of APIs. The registration system (and registration definition service in some examples) may be used to create and use registration objects. The customization system may include the registration definition service for creating and/or generating registration objects. Further, similar to the organization of custom objects, an ontology may include registration objects and/or definitions and an instances knowledge graph that may include registration object instances. The storage system of the multi-service business platform may include a knowledge graph that facilitates associating core objects (e.g., campaign core objects) and associations with registration definitions and custom objects via the ontology. The knowledge graph may further facilitate associating core object instances with association instances, custom object instances, and registration instances via the instances knowledge graph. Further, the system may include a campaign UTM to GUID and validation system that may be connected to the storage system. A set of services that are associated with the storage system may include a calendar system service that may rely on one or more output of the registration definition system. Campaigns of the storage system may be associated with knowledge graph. The storage system may include a set of multi-tenant data stores that may store several types of data including, without limitation, definitions, properties, values, associations, and instances. In example embodiments, the campaign UTM to GUID and validation system and the calendar system of services as shown may be connected to the features and/or components of the storage system. Also, the campaign UTM to GUID and validation system, the registration system, and the registration definition service may be connected to the calendar system of the services indirectly via the storage system.

In example embodiments, a UTM may include one or more attributes that facilitate identification of a corresponding campaign. A value for one of these attributes may be a name of the campaign. This campaign name, which may be a text string including words and spaces (e.g., “My campaign abc”), may be converted into a URL compatible string, such as by replacing spaces with value %20. In example embodiments, this conversion may be expressed as UTM=URL(name), where (name) may be the example campaign name “My campaign abc”, and the like.

In example embodiments, when a campaign name changes, the UTM for the renamed campaign may need to be changed. However, to ensure all named versions of the campaign may be maintained in the CRM, older versions of the UTM may need to be stored separately from, although linked to the changed name campaign. If a UTM of a campaign were to change, then use of the changed UTM may cause a complete break from the prior named campaign. If a campaign of the changed UTM did not exist, then this may break tracking of the UTM completely. In some examples, the UTM may have to be static and permanent which may be typical for most systems. Once it becomes a modifiable entity, most systems may break down and stop working. Functionality to change the UTM of a campaign, which was previously not supported by advertising campaign handling platforms, is described in the disclosure.

In example embodiments, a process for generating UTMs that relies on constancy of a campaign name in a UTM may include taking a campaign name (e.g., a Human Generated Campaign Name (HGCN)), such as “My first campaign.” For use in a URL the name may be converted (e.g., replacing spaces with a symbol) to result in a URL compatible string “My%20first%20campaign.” From this URL compatible string a UTM may be created with a name attribute “&utm_campaign=My%20first%20campaign.” With each renaming of this campaign, a new UTM may be generated by changing the utm_campaign attribute. For example, through a sequence of renaming of a campaign with an object identifier (e.g., ID 36792613638), a corresponding “utm_campaign” attribute value may be URL converted to the following: My%20first%20campaign; My%20campaign; The%20campaign; The%20best%20campaign%20ever

In embodiments, when utilizing a given CRM database for several clients, even though the campaign has been renamed, it may be difficult to create another campaign with any of the previous or current campaign names used for other clients in the CRM. Also, it may be difficult to distinguish between two campaigns with the same name. This may happen because, when the name of a campaign is used as the sole identifier of a campaign in a UTM, it may be unique across multiple versions in the CRM. In example embodiments, in a user interface through which a user may generate a new campaign name, a warning may pop up (e.g., “Couldn't create campaign” warning or “Campaign with this UTM already exists” warning). In embodiments, a given CRM database may be used for several clients so that even though a campaign has been renamed, it may be difficult to create another campaign with an older name in the CRM. A portion of a user interface of the campaign UTM to GUID and validation system may depict an error message that may be displayed when a user attempts to create a campaign (or rename an existing campaign) with a campaign name that may already exist in the CRM. In response to a user entering a campaign name in the required campaign name field, a campaign creation error may be presented to the user.

In embodiments, the campaign UTM to GUID and validation system may be used, even for a renamed a campaign, to reliably retrieve intended information from a campaign UTM. This may be achieved by making a UTM that has a campaign name value, which may be stored in a database (e.g., a CRM database), completely redundant, such as through use of another corresponding identifier in the UTM, such as the GUID for the object (e.g., object ID) in the CRM. This campaign UTM to GUID and validation system may retrieve the intended information directly from the corresponding identifier value(s) (e.g., the GUID and the like) which may be embedded in the UTM. While the UTM may be generated from the name of the campaign, the campaign UTM to GUID and validation systems and methods described herein may generate the UTM from the name as well as the object ID which may be optionally encrypted, and the version (e.g., a version of the campaign that corresponds to the campaign name) may be optionally encrypted. As will be described in greater detail, the object ID value and the version value may be combined and encrypted into a single encrypted string for use in a UTM.

In embodiments, a campaign name may include a human generated campaign name or HGCN. Use of these terms in this disclosure may not require or imply that a human may physically generate (e.g., enter in a computer user interface) a name. Although user entry of an HGCN may be one example embodiment, the systems and processes herein of campaign UTM to GUID and validation may include any other form of generating and/or selecting a campaign name including being completely or partially computer automated. In embodiments, a HGCN may be a familiar or conventional string of characters and may include examples of which are provided in the disclosure. However, any string of characters, whether they correspond to one of the examples herein or have no recognizable connection thereto may be used for the HGCN as described herein. As a further example, while a randomly generated HGCN may seem a bit of an oxymoron, such an HGCN may be used with the systems and processes of the disclosure.

In example embodiments, data for a UTM may include “human generated campaign name+<space>+multi-encrypted object ID+<space>+encrypted version.” In other example embodiments, data for a UTM may include “Human generated campaign name+<space>+multi-encrypted [object ID+<space>+name version]”. In example embodiments, name version may correspond to an index given to the campaign name by the system when a human generated campaign name is established/changed. A UTM text string for use in a URL may require conversion, such as URL conversion(data). For example embodiments in which the object ID and the version are combined and encrypted, this may result in a URL including: &utm_campaign=“campaign_name%20encrypt(36556484252 2)”. For example embodiments in which the object ID and the version are encrypted separately, this may result in a URL including &utm_campaign=“campaign_name%20encrypt(36556484252)%20encrypt(2)”.

As an example, a UTM for a CRM object in the multi-service business framework may include a name attribute/property (e.g., campaign_name). In example embodiments, any property of a campaign object in the framework may have its own versions. In this example, the campaign may be only renamed once (e.g., notice the version of “2” at the end of the utm_campaign string in the disclosure). However, if it was renamed five or six times, the CRM or the framework may store all six versions of the names. Each renamed version may be allocated a next sequential version number so that for a campaign that was originally named and then renamed five times, the version for the most recent name may be “6”. The approach may upend the object ID (e.g., GUID that may uniquely identify this CRM object), then upend the information (e.g., encrypted object ID and version) along with the campaign name, and then may use it to generate the UTM. In this example, even if the name is changed, the system may be able to efficiently process a UTM to get or obtain the object ID and the version after decrypting the relevant portion of the UTM. In example embodiments, the system may directly fetch the name from the object that corresponds to the version in the UTM and may check if the name portion of the UTM is consistent with the name of that version taken from the object. If it is so, then the UTM may be a valid UTM. If not, then the UTM may not be the correct UTM for the corresponding CRM object.

A UTM with this compound utm_campaign attribute value may relate to an object ID (e.g., ID specifically relating to custom objects interaction with the platform framework) in creating a “campaign object” for a data store. This allows users to create their own campaign objects that may be part of the core objects (where core objects may include campaign objects and core object instances include campaign object instances).

In embodiments, systems and processes described herein may include combining human-generated campaign name data for a campaign with an identifier uniquely assigned to a (database-specific) object instance for the campaign. This combining may facilitate identifying a distributed database object instance of a campaign directly from a UTM. This facilitates generating a campaign name (e.g., for use in a “utm_campaign” attribute of a UTM) that may be unique for a given human generated campaign name and may be common across versions of the underlying campaign independently of which set of human generated name(s) for the campaign may be used in a UTM. This provides benefits of more efficient processor utilization when handling all aspects of an advertising campaign associated with use of an UTM, and the like.

One non-limiting example of improved computing efficiency may include direct identification of an object instance in a CRM database from each UTM used in all campaigns being operated through the CRM database. Direct identification of an object may eliminate overhead such as determining a correspondence between a human assigned campaign name and a set of records (e.g., an object instance) in a database (e.g., via an intermediary system that performs a cross reference operation). This overhead, which may be common with some current UTM technology, may be eliminated. Another computing efficiency improvement may include a reduction in data storage and network bandwidth demand for common advertising campaign operations, such as renaming a campaign when a campaign operator may seek to track, among other things, performance differences that may be made to campaign parameters, and the like. At least a portion of the efficiency improvement may be the reduction and/or elimination of maintaining separate object instances for each renaming of a campaign. Details of how these and other efficiencies are obtained by the methods and systems may be described herein.

In example embodiments, when relying on a human-generated campaign name for uniquely tracking campaign activity and performance, renaming a campaign may involve, among other things, duplicating all campaign-specific assets in a campaign database to be accessed under the renamed campaign. Continuity of the campaign across names may be generally lost since there may not be an effective mechanism within a UTM for such multi-name tracking. Further, user interface systems through which campaign names may be generated (e.g., human-generated campaign names) may maintain an up-to-date list of campaign names and may prevent users from selecting a campaign name that may already be in use (e.g., even if it is in use by an unaffiliated third party user of such a multi-service business platform that may include an advertising campaign platform). Further, when multiple users are using such interface systems to generate campaign names, real-time name generation consistency may become a greater complication that may yield poor user experience in some examples.

The methods and systems described herein may use a combined human-generated campaign name (HGCN) with a random and unique identifier for a database object instance of the campaign to provide some advantages over other systems. In embodiments, advantages of the UTM-GUID processing methods and systems described herein may include a process for creating the GUID as distinct from a process of using the GUID with a campaign. This new process may allow for a “more direct” access to a campaign object in a CRM than existing UTM-based campaign systems that may generally require an intermediate look-up step (e.g., to convert the “utm_campaign” UTM attribute into a database index). This new process may also allow for multiple uses of a single campaign name, which may be a human generated and generally human referenced name due in part at least to the incorporation of the GUID into the UTM—this may be important for a multi-tenant unaffiliated client common CRM database. Yet this may allow for revision tracking of changes. Also, this may allow for continuity of campaign performance, while enabling distinction based on when a change may be made. When a campaign name is changed, data before and after the change may be identified and treated uniquely or as a single continuous campaign. Another advantage may include a benefit of using a GUID for a campaign object such that all related objects in a campaign may be identified through the GUID. Yet further advantages to an operator of a multi-service business platform may include use of only a portion of a utm_campaign value to identify which campaign may be associated with the UTM. This may allow the operator to determine that two distinct utm_campaign values may reference different versions of a single campaign. Third-party UTM monitoring software may use the entire utm_campaign value and therefore may not determine that two differently named UTMs are for the same campaign. External tools may receive traffic with a UTM, and on that UTM may be the name. The UTMs of the UTM to GUID and validation system may have a changed shape compared to typical UTMs, at least due in part to the UTM attribute utm_campaign having a non-human readable portion.

Another advantage may be in the use of a JavaScript Object Notation (JSON) array structure (e.g., for the “value” of the “hs_name” attribute), because it may implicitly assign an index to each entry in the array, thereby producing an automatic versioning system by using this index as the version of the encapsulating object and/or of the corresponding HGCN. Yet another advantage may be a result of including both the human generated campaign name string and a corresponding object id and version (e.g., JSON object name array index) because it may act as a validation security feature so that use of the human generated campaign name string and an incorrect encrypting of the object ID and version may be rejected (e.g., the CRM database may not be accessed). In example embodiments, use of a GUID within a UTM may improve ability to implement changes across multiple aspects of the platform where there may be multiple systems that may have to be updated. Some advantages of using a compound UTM name field may include directly accessing the campaign object in the distributed database from the UTM/URL because object IDs may be directly encrypted therein. Further, as described in the disclosure, access to the CRM may be enhanced because the system may compare the name in the UTM to name information in the corresponding object based on the version decrypted from the UTM (e.g., a validation form of security). Because the UTM may be dynamically generated from the CRM database, it may not need to be stored in the CRM in an encrypted or compound form (e.g., like a CRM object). As such, it may be a more inferred value than a value that may be stored.

In embodiments, another advantage of the methods and systems for UTM to GUID processing may include the object ID allowing direct (e.g., lookup table free) access to the campaign source object in the CRM. This may allow faster database access to the object (e.g., Campaign object) in the CRM as the object ID in the UTM may be the unique identifier in the CRM. This core benefit of faster database access may also mitigate the potential name-change issues mentioned herein. This approach may be advantageous on several technical levels. For example, it may speed up and simplify many CRM operations. A benefit may include being able to validate a UTM through validation of the name of the campaign for a given version expressed in the UTM. CRM object properties may store versions. If this validation succeeds, the UTM may be considered valid. In embodiments, another advantage may be that the processes and systems may solve the problem of a UTM being unique across versions of a campaign, at least for versions of the name of the campaign (e.g., as the combination of object ID and version may be unique as object ID may be unique for each campaign). Further, there may be other advantages provided. For example, these methods and systems may solve the need to store a UTM and associate all UTMs (for all names of a given campaign) to a single campaign. Additionally, it may improve a platform operator's ability to implement changes across multiple aspects of the platform (e.g., including multiple systems that may have to be updated). Yet again it mitigates name change issues, such as when a user may prefer to change a campaign name but continue to use the same campaign underlying object while maintaining continuity with all earlier names. Also, a compound utm_campaign value as described herein may support external solutions to the problem of making this compound UTM value human readable to at least some extent. In embodiments, a user interface process may be configured to render a parsed UTM.

The methods and systems of generation and use of a GUID with a UTM for a multi-service business platform may enable advanced advertising campaign control and tracking capabilities. In example embodiments, one substantive benefit of these methods and systems may be facilitating independence of processes to generate GUIDs and instantiate GUIDs for distributed database system management from use of these GUIDs as a mechanism for enriching use of UTM technology, particularly for a multi-service business platform comprising a multi-tenant database of unaffiliated clients. In example embodiments, the methods and systems herein that facilitate integrating use of a GUID with human campaign naming capabilities may further streamline computing processes for operating UTM-based advertising campaign. As an example, a campaign object in a relatively large, distributed object-based database may be directly accessed from a “utm_campaign” attribute value in a UTM due at least in part to encrypting the unique identifier of a campaign object that corresponds to the UTM into this attribute value. Further, these methods and systems may enable independence of a campaign generation and operational framework from an organizational framework for a corresponding distributed database architecture. All that may be required to be shared between the frameworks may be a unique object identifier. Intermediate lookup/cross-reference operations and resources (e.g., a server dedicated to performing campaign name to distributed database object cross referencing) may be further reduced and/or eliminated through these methods and systems. Further benefits enabled through the methods and systems herein may include allowing multiple uses of a human generated campaign name for different clients in a multi-tenant campaign management database. This may be supported at least in part by integrating the campaign management database object identifier (GUID) directly into a UTM context. Without this integration and use of the GUID at the UTM level, campaign naming may be substantively (and from a human user's perspective arbitrarily) restricted to avoid duplicate names. This may be particularly beneficial when multiple unaffiliated clients may be using the common UTM framework for advertising campaigns within a single campaign management database.

Yet further benefits include a degree of revision tracking of changes (e.g., changes to campaign name) of underlying campaigns. In addition to the benefits above, the methods and systems for integrating a GUID with UTM technology may include allowing for continuity of campaign performance tracking, while enabling electing between continuity or distinction as changes to a campaign (e.g., a campaign name) may be made. Continuity may permit a holistic view of a campaign from instantiation throughout the life of the campaign, even when changes to a campaign name may be made. Distinction may permit tracking how changes to a campaign (e.g., those made in coordination with a change in campaign name) may impact performance by permitting tracking and measuring performance for human generate campaign name-based instances of a campaign. These benefits may extend further by reducing computing/data storage resources as changes to the campaign name may be made. Not only may two campaign names be linked with no overhead, but as campaign name changes are made, campaign attribute values that are unique to the renamed campaign may need to be tracked. Campaign elements/attributes that remain constant across a campaign name change may be maintained directly in the CRM database due to the indexing nature of elements within a campaign object. Thus, there may be no need to copy an entirety of a campaign CRM content merely when the campaign name may be changed.

It may be instructive to explore and compare the current UTM process (HGCN-based only) to a new compound UTM campaign name process performed by the campaign UTM to GUID and validation system described herein. In some examples, to create a UTM for a campaign, a system may take a name of the campaign. The name of the campaign may be converted (e.g., encrypted in some examples) in such a way that it may work in a hyperlink because there may be a set of allowed characters. This step of the process URL conversion may be called. In example embodiments, the UTM variable “utm_campaign” may be a length-limited version (optionally encrypted) of the campaign name. Although CRM use rules may enforce that this human generated campaign name may be unique to the customer who generates it, it may not be unique across the entirety of CRM data for a multi-service business platform that may serve several customers. Therefore, two customers may have exactly the same UTM campaign name variable. The new UTM process described herein may apply a similar process as described in the disclosure. Included in the UTM may be some non-human readable information that may be encrypted to allow readily determining of the object within the CRM without having to do an intermediary lookup.

A platform may have 10 million users but only 5 million may fit in a single instance of the platform database. One approach may be to place one half of the alphabet, based on a customer's name, on one server, and a second half on another server, making a lightly distributed database. The system may look at the name and determine which database to select. However, when the size of the database may require 20, 30, 40, 50 database servers, trying to be well balanced such as a simple name-based allocation scheme may be difficult. In such examples, the system may use either an intermediary server that may have enough information to do the look up and determine which server to select to obtain the data, or the system may use a mathematical operation (e.g., a random hash) to determine the server. In some examples, a distributed system in which no one server stores all the data may include an operation in the middle to determine how to get to a final storage location/server.

In embodiments, using a unique ID (e.g., GUID and the like) for each object in the CRM in the multi-service business framework, each object may be found through its ID. The multi-service business platform may have access to and/or may provide multiple APIs to do this. For example, to find a specific object given its ID, the platform may simply query using one of the platform CRM access APIs. The GUID may be considered the CRM equivalent of a primary key in a database. In example embodiments, a GUID may be applied to a range of objects in the CRM and may include custom objects with respect to the ID numbers. In embodiments, once an object ID is available, the system may directly query (e.g., via the API and the like) that object based on the ID. Some objects which have multiple campaign names. If a campaign were renamed multiple times, the corresponding campaign object may be stored under the ID for multiple versions of the name. Even though this campaign was renamed multiple times, the corresponding campaign object may be accessed independently of the various names because the campaign UTM to GUID and validation methods and systems may generate a UTM that may use an encrypting of the unique object ID. The system may use that object ID (decrypted from the URL/UTM) to directly query a CRM distributed database for the campaign object. By retrieving the object from the CRM, properties of the object, including the entire group of properties of the object along with older versions of properties of the object stored in the object, may be accessed.

An exemplary action associated with the compound UTM campaign naming techniques employed by the campaign UTM to GUID and validation system described herein may include using a URL to easily access the specific campaign object in a distributed CRM database. This may be due at least in part to the system's ability to directly determine a unique identifier (GUID) of the object with at least the UTM portion of the URL. This action may include fetching the utm_campaign value in the URL and decrypting the last portion of the value to get the version of the object that may be associated with the campaign name found in the first portion of the utm_campaign value. This version (e.g., the nth version) may also denote how many times the campaign object has been renamed. Another action may include obtaining the object ID (e.g., derived by decrypting the last portion of the utm_campaign value as noted in the disclosure), and then using the obtained object ID (e.g., as a database object index) when fetching the campaign object from a CRM. Yet further, an action may include validating the UTM name in the URL with the nth version of the campaign's name. If it matches, the system may validate access to and/or pass the object.

In example embodiments, a URL may be used in a process to decrypt a GUID of a campaign object associated with a UTM. The system may fetch the last value in the URL and may decrypt it to get the version, which may also denote how many times the object ID is encrypted. The system may next decrypt the object ID n times where n may be the version number. The system may next obtain the object ID and fetch the campaign from the CRM. The system may then validate, e.g., by matching the name of the nth version of the campaign's name. If it matches, the system may validate or pass the object.

In example embodiments, an example process to generate a “utm_campaign” parameter for a UTM from a campaign object in a CRM may include the following steps: (i) take a human attributed campaign name (HGCN), such as the latest name from the “names” array in the corresponding object=“My first campaign”; (ii) take the object ID of the campaign object and the version of the HGCN in step (i) (this may be the index of the HGCN in a name array of the object)=“objectld=36792613638 and version=1”; (iii) encrypt object ID version (e.g., use advanced encryption standard (AES) encryption) to form a “versioned_ID”=“encrypt(“36792613638 1”)->+9sXBkwpk/JzQYWOHpRdvw==”; (iv) append this encrypted “versioned_ID” to the campaign name from step (i) (e.g., <campaignname><space><encrypted version_ID>)=“My first campaign +9sXBkwpkazQYWOHpRdvw==”; (v) URL may convert the above payload=“My%20first%20campaign%20+9sXBkwpkazQYWOHpRdvw==”; and (vi) assign it as a value of the “utm_campaign” attribute for the URL.

With each renaming, a new URL-converted UTM may be generated. For example, a campaign with an object ID (e.g., object ID: 36792613638) may be converted to the following UTMs (e.g., where each UTM may reflect an impact of renaming the campaign): My%20first%20campaign%20+9sXBkwpkazQYWOHpRdvw==My%20campaign%207sQO5Arq1+YPGVXaOjHMnA==The%20campaign%20moOlwPraVOmX5hGQoscgUQ==The%20best%20campaign%20ever%20NOjjklTe58jAavCjfpds2g==

A process may include a step in which a campaign name for a campaign object may be provided and/or obtained. An object ID and version may be extracted from the campaign object. The extracted object ID and version may be encrypted. The encrypted object ID and version string may be appended to the campaign name from. A URL UTM payload may be converted that may facilitate identifying the campaign object from the URL. For each subsequent renaming of the campaign, a new URL UTM payload may be generated.

A process is provided for generating a UTM campaign identifier (e.g., “UTM_Campaign”) that may uniquely map to at least one distributed CRM database (e.g., single distributed CRM database) object for each human generated name. The process produces a UTM that may be unique for a specific human assigned/generated campaign name while maintaining direct access to the campaign objects in the distributed CRM database identified by a GUID independently of the human generated campaign name (HGCN). A value is generated for a UTM campaign identifier attribute (e.g., utm_campaign) for each HGCN that may uniquely map to a distributed CRM database object instance identified by the GUID. A unique identifier (e.g., a GUID) may be received/retrieved. This GUID may be generated using the random number generation techniques described herein and elsewhere that may include producing a data string that may be substantially unique. This GUID may be associated in a one-to-one relationship with an object instance in a distributed CRM database or the like that may optionally be configured for use with an advertising campaign that may rely at least in part on existing UTM technology. The GUID may be received from a random number generating system. In example embodiments, the GUID may be retrieved from the CRM database. The CRM database may be configured with at least a default advertising campaign object instance (e.g., optionally referred to herein as a core object) to which the GUID may be assigned. In example embodiments, the GUID may be preassigned to one of a set of default advertising campaign object instances that may be allocated as new campaigns that may be instantiated in the database. In example embodiments, the GUID may be generated contemporaneously with instantiation of a new campaign, such as when a user may request creation of a new campaign.

In embodiments, a name array within an object instance may be depicted in the exemplary JSON script in Appendix A attached hereto that may include a GUID value for “objectId” of “36792613638” and name array “versions” that may include four (4) versions of a HGCN for this GUID/campaign/object instance. Each “value” entry in the “versions” array may represent a unique HGCN for the advertising campaign with GUID “36792613638”. In example embodiments, each indexed entry in the “versions” array may be treated by the methods and systems herein as a unique version of the campaign that may correspond to the object instance. Each entry in the “versions” array may be accessed by an index number. When a campaign may be renamed (e.g., given a new HGCN), an entry may be added to the “versions” array. Therefore, in this JSON script example embodiment, campaign 36792613638 may be renamed three (3) times since being instantiated. Following conventional JSON script rules, an order of campaign renames may be merely the reverse of the order of elements presented in the “versions” array. In this example, the HGCN at instantiation of this object instance (e.g., “My first campaign”) may, by default, be assigned index 1 in the “version” array. The most recent name may be “The best campaign ever” which may be assigned index 4 in the array. For examples throughout this disclosure, an array index value for a given HGCN may correspond to a unique version of a campaign assigned to a GUID. Therefore, version 1 of the campaign identified in the database as 36792613638 may correspond to the first HGCN and version 4 of this campaign may correspond to the most recent HGCN.

In example embodiments, information, such as object ID, version, and other properties and/or their values may be stored in an encrypted form in a CRM object, such as a campaign CRM object instance and the like. During an instantiation of an object instance for a campaign, the next indexed entry may be entry 1 in the array. A combination of the GUID and index that may correspond to the HGCN (which may also be referred to herein for some example embodiments as the version of the GUID) may be encrypted. A range of existing encrypting techniques may be applied, including without limitation advanced encryption standard (AES) encryption. In example embodiments, for a GUID of 36792613638 and a version of 1, AES encryption may produce: “+9sXBkwpk/JzQYWOHpRdvw==”

The encrypting of the combination of GUID and version may be appended to the corresponding HGCN and recorded as a value of a UTM attribute for use in UTMs for the campaign. In embodiments, this UTM attribute may be a “utm_campaign” attribute. A “utm_campaign” attribute value for one of the HGCNs in the “versions” array may be generated to include a concatenation of an HGCN with an encrypting of the “objectID” for the campaign and the index into the “versions” array that may correspond to the selected HGCN, such as: <<My first campaign>><<AES encrypting(36792613638 1)>> that when converted for URL compatibility may result in a “utm_campaign” attribute value of: <My%20first%20campaign%20+9sXBkwpk/JzRdvw==>>.

The process may further include combining the “utm_campaign” value generated with other campaign attributes to produce an HSGN-specific UTM, such as for use in an advertising campaign, such as in a URL and the like. UTM-GUID2 may further include an optional process in which the UTM generated may be used in an advertising campaign, such as by encrypting the UTM into a URL compatible form and applying the encrypted UTM in an Internet Protocol-based advertising campaign, email campaign, embedding in web pages (e.g., as a selectable link), and the like. The process may be performed when a new CRM database object may be instantiated. These processes may be performed for several campaign instantiations, such as to prepare a set of campaign CRM object templates. One or more CRM object templates may be configured further as a core object, which may include specific default values. In example embodiments, default values of a core object may include values for an advertising campaign as may be defined by an operator of a multi-business service platform. Without impacting the scope or uses of the methods and systems described herein, an object instance that may be uniquely identified by a GUID may be configured for multi-service business platform features other than advertising campaigns.

Encrypting processes and concatenating processes may optionally be performed during activation of a campaign and the like. Generation of a UTM, such as may occur, may be performed contemporaneously with process, but may alternatively be performed distinctly, such as during execution of a campaign for the HGCN when a UTM may be required, such as when a user may select a link in a webpage, email, posting, and the like that may be part of a UTM-based campaign.

A process for retrieving a CRM object based on a UTM in a URL with the campaign UTM to GUID and validation system (e.g., campaign UTM to GUID and validation system). The process is for a campaign UTM to GUID and validation system (e.g., campaign UTM to GUID and validation system) of the multi-service business platform to validate campaign objects and convert a campaign UTM to GUID. The system may receive and/or fetch a campaign UTM. The system may use a URL to decode the campaign UTM. The system may fetch the last value and decrypt the URL to get a version for the campaign UTM. The system may obtain an object ID for the campaign UTM (e.g., from the CRM). The system may decrypt the object ID n times based on a number of versions for the campaign UTM. The system may validate a name of the nth version of the campaign. If it matches, the system may validate or pass the campaign UTM. The system may convert the campaign UTM to a campaign GUID.

In embodiments, the process includes receiving a URL that may include a UTM that includes one or more parameterized attributes. In embodiments, at least one UTM attribute may be a “utm_campaign” attribute. The UTM may be processed so that at least the “utm_campaign” attribute and corresponding value(s) may be distinguishable. A portion of the UTM attributes including at least the “utm_campaign” attribute may be parsed. Parsing the “utm_campaign” attribute may be based on an understanding of a predetermined structure for a value thereof based on the methods and systems described herein for generating a value of a “utm_campaign” attribute. In embodiments, a value for the UTM attribute “utm_campaign” may be structured as a text string of a human generated campaign name (HGCN) that may be followed by an encrypting of an identifier associated with the HGCN. The methods and systems for UTM generation and use in association with a multi-service business platform may be configured to process UTM attributes, such as “utm_campaign” based on this understanding. This may provide an advantage over other, third-party service platforms that may rely on UTM technology for managing digital communication/advertising/promotional/tracking campaigns by facilitating a determination that each of two or more distinct “utm_campaign” values detected in such promotional and the like efforts may reference a common campaign. These and other advantages are described further in the disclosure. Processing at least a “utm_campaign” attribute of a UTM may result in detection of: (i) a human generated campaign name (HGCN) portion, and (ii) a string of characters conveying an encrypting of an object identifier (e.g., GUID) and a version. In example embodiments, a value for a “utm_campaign” attribute may include the following text: <<My first campaign +9sXBkwpk/JzQYWOHpRdvw==>>. Processing this “utm_campaign” attribute value may include separating the HGCN portion (UTM-408) <<My first campaign>> from the encrypted portion (UTM-410) <<+9sXBkwpk/JzQYWOHpRdvw==>>. The HGCN portion UTM-408 may be stored for later use, such as for taking security measures including validating the UTM conveying this “utm_campaign” attribute value.

The encrypted portion (e.g., object ID/version encrypted string) may be passed to process where the encrypted portion may be decrypted, such as through use of AES decryption and the like. This decrypting process may be configured to produce two decrypted output values: (i) an object identifier value, and (ii) a version value. As described in the disclosure, the object identifier value and version value may be uniquely associated with an object instance in a CRM distribute database of the multi-service business platform. For example, the encrypted portion <<+9sXBkwpk/JzQYWOHpRdvw==>> may be decrypted at UTM-412 using, for example, AES decryption to produce an object identifier value 36792613638 and a version value 1. In example embodiments, decrypting of the encrypted portion may be performed using the same approach used to produce the encrypted portion.

In embodiments, optional process may be performed after the process to validate the encrypted portion (e.g., validate encrypted string and decrypted version). The decrypted version value may be used (e.g., as an index into an encrypted portion validation table) to identify a stored encryption, such as in the encrypted portion validation table. If, during this optional step, validation is successful, such as if the encrypted string matches a corresponding value in the validation table, the process may proceed such as by proceeding to process. However, if this optional validation step fails, the may be terminated by proceeding to termination UTM-426. Actions taken at termination may include notifying an administrative user.

In example embodiments, the decrypted object identifier value may be used, such as by a secure and/or system process, to access a CRM database of the multi-service business platform to retrieve a corresponding object instance (e.g., based on decrypted ID). Data resulting from process may include information that facilitates validating the “utm_campaign” value parsed in step. In example embodiments, data resulting from process may include one or more portions of a JSON script, which may be described in the disclosure.

In embodiments, the version value decrypted from the encrypted portion may be used as an index into an array of campaign names found in the object retrieved. In this example, the decrypted object identifier value may be 36792613638 and the version value may be 1. This indexing of an array of campaign names may result in a version-specific HGCN that may be stored for performing security measures to secure a CRM and the like database of the multi-service business platform. Exemplary techniques for using the version value as an index into an array of campaign names, such as to retrieve a version-specific HGCN, may be shown in the JSON script herein and in the accompanying disclosure. The previously stored HGCN retrieved from the “utm_campaign” attribute value may be used to validate the UTM received. In embodiments, validating may include comparing a pair of corresponding HGCN values, such as the stored HGCN and the version-specific HGCN.

Based on a degree of comparison (e.g., text string matching, hash and match, and the like), the UTM received may be validated or may be invalidated. If a result of validating confirms that the UTM received at UTM-402 is invalid, access to the contents of the database object instance that corresponds to the object identifier value portion of the “utm_campaign” attribute may be prohibited. In embodiments, if the HGCN retrieved from the object instance identified in the encrypted portion of the “utm_campaign” attribute does not match the HGCN portion of that attribute, then the UTM received may be invalid. Action taken after an invalid UTM determination may include a range of remedial and security actions, such as halting a process executing that has provided the received UTM, flagging the condition to an administrative user, and the like. However, if a result of validating indicates that the two HGCNs sufficiently compared (e.g., are duplicative), then access to at least the portion of the CRM database containing the object instance identified by the decrypted object identifier may be granted.

In example embodiments, access to content of the object instance determined may be granted based on a degree of confidence in a process or user that has requested access to the object instance, such as by providing the URL with UTM attributes received. As an example, if a user process, executing in a secured user space, has been flagged by a system security monitoring facility as secure for the purposes of accessing at least a campaign portion of a CRM database of the multi-service business platform.

In example embodiments, the UTM to GUID and validation system may provide a new way of generating UTM fields. For example, given an object ID of the campaign for which one wants to generate a corresponding UTM, one could combine an encrypting of this object ID followed by space, followed by an encrypting of the version of the campaign name. This may be used to generate a UTM for a renamed campaign. In some previous example systems, a campaign tracking system may have used the campaign name as the only campaign identifier in a UTM. In this example new unique way of generating a UTM, it may be possible to decrypt at least a part the UTM (e.g., the encrypted object ID and encrypted version) to access and retrieve information from the corresponding campaign object. In example embodiments, as noted using a GUID, it may be possible to use that object ID to directly query the object. Information in the object may include a campaign name and corresponding version. If the campaign name in the UTM may get validated against (e.g., matches) the campaign name in the object that corresponds to the version, then the system may determine that this UTM may be a valid UTM and the system may provide the information of the campaign found in the object. If this validation does not work, it may mean that a third party may be trying to access the object so the system may not provide any information.

In example embodiments, a primary benefit of this new way of generating UTM fields may be saving a database step or process when using the newly generated UTM to access a corresponding campaign object. Notwithstanding a campaign tracking system's ability to support changing campaign names, reducing the processing required to access a campaign object remains a benefit. This benefit may exist even if a system does not support renaming campaigns and UTMs. In embodiments, validation when fetching a campaign by UTM may be performed in the following exemplary sequence of steps: (i) UTM “utm_campaign” parameter passed in the URL=“The%20campaign%20moOlwPraVOmX5hGQoscgUQ==”; (ii) convert from URL coding to get the UTM “utm_campaign” string entry=“The campaign moOlwPraVOmX5hGQoscgUQ==”; (iii) split this string by <space> and get the last portion from the split data=moOlwPraVOmX5hGQoscgUQ==; (iv) the remainder is the human-generated campaign name (HGCN)=“The campaign”; (v) decrypting “moOlwPraVOmX5hGQoscgUQ==” may provide direct access to the CRM object, such as decrypting gives object ID=36792613638 and version=3; (vi) since the object ID may be a unique identifier of CRM objects, this may allow for the ability to quickly fetch the object independent of the HGCN (e.g., with all versions); (vii) validate if the third (3^{rd}) entry in name versions array is “The campaign”; and (viii) If yes, the UTM is valid and corresponds to source campaign object with the object ID 36792613638.

In embodiments, UTM generation and validation for a CRM object instance may be similar to core CRM objects. In embodiments, each campaign CRM object instance may have at least one name and properties associated with versions. Information from the campaign CRM object instance such as object ID, campaign name version, campaign name, etc. may be extracted and used to generate a UTM using the exemplary process above. Even if the name changed, object IDs and versions may be obtained from a URL after decrypting the relevant portion thereof. A UTM may be validated by fetching an object instance (e.g., using the GUID found in the UTM) and checking if the human generated campaign name in the UTM may be consistent with the name in the name versions array of object instance based on the version value decrypted from UTM.

In embodiments, a campaign object instance may be queried by an object ID. Multiple database query-type APIs may be used to find campaign objects by IDs such that any object may be located by querying the related ID (e.g., unique identifier for the object). Where objects have multiple names (e.g., renamed multiple times), there may be multiple versions that have the same encrypted object ID which may be queried. Locating the campaign object instance may provide access to an entire list of properties and various versions of the object instance. Use of a GUID that identifies a campaign within each UTM of the campaign may also provide an advantage for a platform capable of handling a single campaign with multiple name variants at least because third-party campaign performance tracking systems may detect the distinct campaign names without any feasible way of determining that two campaigns with different “utm_campaign” values are derived from a single campaign.

In embodiments, use of JSON or the like array indexing capabilities, such as for capturing an advertising campaign, may provide an implicit form of campaign version control. As each new human generated campaign name is introduced into a campaign name array (which may be a prerequisite when making other changes in a campaign), the index of the new HGCN may become the version of the campaign. Further, use of the JSON (or the like) array indexing capabilities enables various types of validation that may be performed throughout the life of a campaign and/or when accessing a CRM or other database of the campaign at least because each new human generated campaign name may produce both a unique version value and a unique encrypting of the version and GUID for the campaign. Therefore, a version and/or a campaign GUID may be validated against a HGCN portion of the “utm_campaign” attribute. Further an encrypting of the GUID/version may be validated for each HGCN and for each version. Any mismatch among HGCN, version, GUID, and encrypted GUID/version may be detected and flagged for enhancing safety of campaign data. This may be particularly helpful for multi-tenant CRM databases where data collisions, either inadvertent or intentional may be detected and remediated.

In embodiments, a multi-service business platform may be organized around an object-oriented database, such as a customer relationship management (CRM) database. Such a CRM database may include a range of data objects (e.g., types of objects) that each contain several data fields and corresponding field values that may be configured for a purpose, such as operating an advertising campaign, tracking correspondence, and the like. One or more of these data objects may be instantiated as a variety of object instances that effectively replicate a structure of the data object with instance-oriented values. An advertising campaign object type structured with a “campaign_name” field may be instantiated as a first instance of a “campaign” type object with a value of “first” attributed to the “campaign_name” field and a second instance with a value of “second” attributed to the “campaign_name” field.

In embodiments, structures of objects and values assigned to fields of such structure in a CRM may be configured for core functionality of a multi-service business platform. However, the content of these objects may be utilized in various projects, applications, and contexts, such as a calendar, CRM activity monitoring, CRM performance, export to/from 3rd party platforms, and the like. Further, not all such uses, applications, and external systems may be directly compatible with the structures and content of objects in the CRM database. As an example, a campaign type object may include a “campaign start date” field with a mmddyyyy structured content. A calendar application (e.g., using a calendar system service) may require a minimum set of information about a campaign to ensure that it may be displayed properly in a visualization of a calendar that may display campaign activities and other information. Such a calendar application may require a “start date” attribute in the form of “yyyymmdd” to visualize activities. Therefore, it may be beneficial for some type of easily-performed adaptation to occur when a calendar application is requested/instructed/automated to display the campaign type object (and related activities). The registration pattern systems and processes described herein may facilitate this adaptability through new and interesting uses of elements stored in a CRM database. In general, new types of CRM database elements, referred to herein as one or more of a “registration definition element” or a “registration association element”, may provide a standardized approach for enabling a range of database content utilization, maintenance, and access capabilities. When these new types of registration data structures (herein registration elements) are stored in a database, such as in a database of a multi-service business platform, such a database may be configured to be self-adapting for new and interesting uses, such as CRM-powered applications, third-party applications, interfacing the CRM with other portals, other systems, CRM object maintenance, and the like.

A few terms used herein may be related. In general, the term “registration pattern” may in certain contexts refer to an overall approach of using data in the CRM (or stored in association with the CRM) to facilitate operating/managing/maintaining other elements (e.g., objects and the like) and/or may in certain contexts refer to techniques for facilitating operation of applications, such as CRM-powered applications and the like that make use of objects and object content. In example embodiments, this overall approach may include computer implemented systems and methods that perform registration pattern operations. In general, the term “registration definition” may refer to an arrangement of data (e.g., a syntax, ontology, and the like) that may facilitate use of object properties and their values by applications (e.g., generally “consumers” of object properties) independent of structural or logical differences between how the data may be represented in the CRM and how a consuming application/portal/user/system may require the data to be represented. In general, the term “registration association” may refer to an arrangement of data that may facilitate maintaining consistency of related (e.g., associated) objects in the CRM. Generally, the term “registration element” may refer to any data item/structure, including registration definitions and registration associations, that may be useful for implementing the systems and processes of registration patterns described in this disclosure, that may be stored in or in association with the CRM. In general, an instance of a registration pattern, referred to herein as “registration association element instance”, “registration definition element instance”, or “registration element instance” may refer to a CRM object type-specific registration association or definition that may be stored in or in association with the CRM. As an example, a registration definition campaign object-type specific element instance that is stored in or in association with the CRM may be referred to herein as a registration element instance. In example embodiments, a registration association that is stored in or in association with the CRM may be referred to herein as a registration element instance. In example embodiments, use of the term registration patterns may refer to processes and systems described herein that employ registration definitions, registration associations, registration elements, and/or registration elements instances. In example embodiments, registration associations may be created and used to link a registration definition with (e.g., by association or relationship to) various elements including registration elements, custom objects, core objects, other objects, other registration definitions, and the like.

In example embodiments, a registration definition or a registration association may optionally be stored within (or in association with) a customer relationship management (CRM) data set. Stored registration definitions and/or registration associations may be referred to herein as registration elements. While registration elements may be embodied similarly to one or more objects in the CRM data set, use of the term “element” herein when applied to the term “registration” (e.g., a registration element) may connote a data item/structure stored in or in association with a CRM that may embody content, structures, attributes and the like that may not be fully compatible with other objects of the CRM. In example embodiments, registration elements may allow, among other things, other (optionally pre-existing) objects (e.g., custom objects and/or core objects) to be adapted for new uses and processing without forcing use and/or processing constraints that may require altering the pre-existing objects. A benefit of using registration patterns may be that these new and adapted uses may occur without requiring new code to be written (or existing code to be modified) for each such use. Use of registration patterns may also eliminate needing to create use-specific shadow objects in the CRM. For example, allowing a pre-existing CRM object (e.g., webinar object, seminar object, campaign object, and the like) to be processed for display by a calendar application may occur. In example embodiments, as described in the disclosure, core objects (e.g., which may be predefined) may include contact objects, company objects, deals objects, and ticket objects. New objects that may not be predefined objects may be referred to as custom objects. In some examples, the webinar object may be a unique object (e.g., portal specific object) that may be similar to a custom object.

In embodiments, an aspect of registration pattern systems and processes functionality may be using registration elements, optionally stored in the CRM, to configure a CRM powered application. This may enable the CRM to have its own configuration and adjustment mechanism, which may make processes easier for customers who want to closely integrate with the CRM and which may be simple for integrators. In example embodiments, one benefit may be that all access may be made through a single application programming interface (API) or another programmatic interface. In some examples, a second system for managing interactions with the CRM may not be required for various applications, services, and third-parties to interact with the CRM. Providing access to the CRM through a single API or other programmatic interface may eliminate such second systems using a separate database to hold configuration information for these types of CRM interfacing processes.

In an example, an integrator uses a specific data structure for defining an online university course object, and the integrator prefers that these types of courses show up in a calendar application (e.g., rendered on the CRM-powered calendar application such as to announce when the courses were being taught). The integrator may create a registration definition (e.g., registration schema for some examples). The integrator may optionally store this registration definition as a registration element in the CRM. Use of this registration definition, such as by the single API in the disclosure, may enable the calendar application to interpret the integrator's specific data structure to facilitate rendering course information in a calendar. The integrator course object may be rendered as a fully-fledged, fully integrated object in the calendar. Using registration definitions as a form of registration patterning may be used with other types of CRM-powered applications, such as a campaign application. With use of a campaign application compatible registration definition (e.g., a registration definition that facilitates mapping content/fields of the specific course object to campaign object content/fields), a course object of the integrator may appear to a campaign application as if it were integrated.

The registration pattern system and process may avoid the need for a two-system approach. While the examples herein may be based on online types of events (e.g., university courses, blog posts and the like) support for offline events (e.g., events that may not have an online component but may be physical events), for example, may be captured and supported by the registration pattern systems and processes described herein. In example embodiments, a registration definition element instance may be tied to a target consuming application-specific registration pattern that may be applied against several types of CRM objects (e.g., seminars, webinars, blog posts, emails, campaign elements, and the like).

In example embodiments, a registration association may be a registration pattern variant (optionally stored as a registration element within the CRM) that may allow for, among other things, establishing/maintaining continuity of content and structure of related objects in the CRM based on monitored CRM events, such as changes to one or more objects in the CRM (e.g., a change in an email distribution date). Use of registration associations when monitoring CRM events may facilitate factor-based CRM reporting across a CRM-based multi-service business platform and the like, for example. In example embodiments, being able to tie a registration association across the platform framework may facilitate reporting on various factors that may impact more than one CRM object. In example embodiments, data and information in a CRM data structure (e.g., a distributed database and the like) may be associated with one or more objects. In example embodiments, given a list of customers, each individual customer may be represented by their own CRM object. Similarly for a list of blog posts, each blog post may be represented by its own CRM object. From this perspective of managing elements in a CRM data set, registration patterns (e.g., definitions, associations, and the like) may be similarly configured or structured. For example, a calendar registration definition (e.g., referred to herein as a calendar registration definition element instance) may be stored in the CRM; however, this calendar registration definition may be a different type of object compared to an object type for use by a campaign application.

In example embodiments, registration patterns may allow for providing support for new types of data to a calendar, such as webinar data. When a CRM object for a webinar is ready, an administrator may create a calendar registration definition for the webinar object that may, for example, facilitate use of information in the webinar object by a CRM-powered calendar application. In example embodiments, this webinar object-to-calendar application registration definition may contain a field that identifies that it is for the webinar object type. In example embodiments, a start date may be a field on the webinar object (e.g., color coded start date such as yellow by default when rendered in a calendar application). Another webinar object field may capture the title. A webinar may be a recurring item such that there may be another field regarding how often the webinar occurs. In example embodiments, a webinar object (or other CRM object) may have up to ten (10) or twenty (20) or more different data fields to which a corresponding registration definition (e.g., a webinar-to-calendar registration definition) may be applied for integrating the webinar object with a CRM-powered application, such as the exemplary calendar application. In example embodiments, for each distinct type of object to be rendered on a calendar, there may be a separate registration definition. For example, there may be one registration definition for blog posts, one registration definition for website pages, one registration definition for tasks, one registration definition for campaigns, and the like. In example embodiments, this may be accomplished in a database table. In example embodiments, there may be separate registration definitions for each type of data (e.g., CRM object, such as a webinar object) to be rendered in a calendar. A database table may include a calendar application row that identifies what types of data may be provided to the calendar. It may also identify minimum required information to be provided to a calendar application so that an object may be displayed on the calendar. This information may be used to query the CRM data set for webinar objects to be rendered in the calendar.

One advantage to having all of this data and information in a single CRM and using a CRM object-like element to store a registration pattern data structure may be that there is no need to give outside vendors, integrators, or customers access to two different systems (e.g., the CRM and the separate database noted in the disclosure). Further, this may all be performed through a common set of APIs (and in some example embodiments a single API) used to access the CRM. In an example, rather than having to access the CRM to populate a bunch of data into a data set, and then logging into a web page (e.g., that includes a control panel) to arrange the data in the data set for configuring a calendar application, or rather than requiring access to two different APIs (e.g., one API for the CRM and one API for the calendar), use of registration patterns may facilitate accessing the CRM and configuring the accessed CRM data for use by a calendar without needing resources external to the CRM. Once granted access to the CRM through, for example, a customer portal, an integrator may create new CRM objects and corresponding registration definitions to keep processes running smoothly.

A multi-service business platform may further include a campaign urchin tracking module (UTM) to globally unique identifier (GUID) and validation system for enabling efficient and disambiguated access to a campaign object in a database, such as a customer relationship management (CRM) database based on an encoded string in a UTM property of a uniform resource locator (URL). The multi-service business platform may also include a registration system of registration patterns that enable independence of applications that consume CRM object data from the underlying structures of those objects while further enabling efficiently maintaining consistency and updating of objects. The campaign UTM to GUID and validation system and the registration system may communicate with various systems, devices, and data sources of the multi-service business platform.

A registration system (that may include a registration definition service) connected to a storage system and to a customization system (that may include a registration definition service) via a set of APIs. The registration system (and registration definition service in some examples) may be used to create and use registration patterns. The customization system may include the registration definition service for creating and/or generating registration elements. Further, similar to the organization of custom objects, an ontology may include registration associations and/or registration definitions and an instances knowledge graph that may include registration definition and/or association element instances. The storage system of the multi-service business platform may include a knowledge graph that facilitates associating core objects (e.g., campaign core objects) and associations with registration definitions and custom objects via the ontology. The knowledge graph may further facilitate associating core object instances with registration association element instances, custom object instances, and registration element instances via the instances knowledge graph. Further, the system may include a campaign UTM to GUID and validation system that may be connected to the storage system. A set of services that are associated with the storage system may include a calendar system service hat may rely on one or more outputs of the registration definition system. Campaigns of the storage system may be associated with the knowledge graph. The storage system may include a set of multi-tenant data stores that may store several types of data including, without limitation, definitions, properties, values, associations, and instances. In example embodiments, the campaign UTM to GUID and validation system and the calendar system of services as shown may be connected to the features and/or components of the storage system. Also, the campaign UTM to GUID and validation system, the registration system, and the registration definition service may be connected to the calendar system of the services indirectly.

In example embodiments, the systems and processes of registration definitions described herein may include features that relate generally to a registration pattern with respect to a customer relationship management (CRM) system (also referred to as CRM). In example embodiments, the CRM may include customer objects, content objects (e.g., blog post CRM objects), registration definitions (e.g., calendar registration definitions), and the like. When a “new” (e.g., new to a calendar application) type of object in the CRM (or new to the CRM) may be added to an application (e.g., calendar application), registration definition information may be updated or created for this “new” type of object (e.g., based on registration definition types such as a webinar definition type). When data of a CRM object that has not previously been used by a CRM-powered application (e.g., calendar application) is used, corresponding registration data may be updated. In this example, a registration definition element instance (e.g., within a calendar application registration definition element) that may be linked to the CRM object (e.g., based on the CRM object type) may be updated to reflect how this previously not relied upon data is to be handled by the calendar application.

In embodiments, registration definitions may map attributes of a source object (e.g., Email sent date) to generic fields required by an application (e.g., start date for an event in the calendar application). Further, registration definitions may include a set of definitions on how to process items. Yet further, in addition to mapping data, registration definitions may also contain configuration information for instructing applications about use of these registration definitions, such as one or more conditions that may need to be present in a corresponding definition and/or object (e.g., a master registration definition activate/deactivate parameter value) for the registration definition to be applied. Further, use of specific features of a registration definition may be conditionally applied based on similar feature-specific context. In this way, an entire registration definition may be disabled or only portions of it may be disabled while others may be enabled. In embodiments, registration mappings and definitions may be utilized for different types of registration patterns. For example, a marketing calendar may support a campaign object type as depicted in a user interface (UI) filter that may allow a customer to display the campaign object or not by adjusting a field in the UI. The UI may display a code that the campaign object may be currently enabled for the calendar application use. Adjusting the field in the UI may send a request to the platform for disabling it from being rendered in the marketing calendar so that the campaign object may not appear anymore. Such a UI may be useful because this process of enabling/disabling does not apply only for enabling or disabling an object type but may also be used for changing a property in order to show the proper name or the like. In some examples, to bring campaigns back on the marketing calendar, the system may be used to do the inverse and change the UI field to set it to “enabled”. In embodiments, relying on the UI for registration patterns, which are described in the systems and processes herein, may allow for configuring a CRM object type for a given example in a relatively dynamic way. In embodiments, the UI and the like may rely upon APIs to effectively make the changes described in the registration definitions (e.g., enable/disable rendering of a campaign object in a marketing calendar).

In embodiments, this dynamic configuration mechanism may be used for dynamic association of assets with campaigns through use of a campaign registration association. In embodiments, different registration patterns may be used for the campaign association at least because a campaign may not require all the fields that a calendar requires. In embodiments, similar processes may be applied here to disable use of an asset in campaigns so that the asset may not get associated with campaigns. In examples, a user may merely use the UI to disable this registration. In embodiments, some other information from an asset may be needed for fulfilling the campaign association.

In embodiments, use of a registration definition and/or association may be activated or deactivated through use of one or more properties of an object, such as a scope property. In example embodiments, when visualizing a marketing calendar, for example that may not have a “MARKETING EMAILS” scope property defined, all the marketing emails may not be accessible to the calendar (e.g., not returned by use of a registration pattern). In example embodiments, use of some features for activating and deactivating use of registration patterns may depend on the user or the portal, which may be using/looking at the current calendar. In example embodiments, another approach for enabling and disabling use of registration patterns may include a gating strategy. In example embodiments, a concept of gating, for example, for release of a new feature, may allow for controlled release of the feature across one or more of the portals. Gating may enable gradually releasing of the feature for different portals, such as in order to have control over bugs or some problems that the new feature may introduce. In embodiments, gating may be enabled by a registration being configured with a gate name property. If a registration pattern includes a gate name property (e.g., “BETA”), and a portal (e.g., consuming application and the like) may not be enabled (gated) for using this BETA feature, it may not access portion(s) of objects defined in this “gated” registration. If the application/portal is enabled for, “BETA” features, the corresponding registration pattern may be used to facilitate access to object content gated by this feature.

Another mechanism by which registration aspects may be activated/deactivated and/or enabled/disabled may include use of optional properties in a registration data structure. In example embodiments, a consuming application, such as a calendar application may identify object properties as being optional. A property that is optional may be processed by the registration pattern, but if it is not available in the source object being processed, the property may be ignored when rendering the object in a calendar, for example. Although optional properties are not mandatory per the target consuming application, when they are present and when there is a value for them in the source object, the optional properties may enable specific features for an application (e.g., for a marketing calendar application and the like).

Records may be created in the customer relationship management (CRM) database to register other records (e.g., email, contact, company) with CRM powered applications. This may be compared to other approaches including, without limitation, an external set of mappings or target consumer-specific CRM-processing code. The techniques described herein for registration patterns may power the CRM by using its storage and access capabilities and functions as a plug-in mechanism. This may further benefit the CRM because the registration elements may be created substantially similar to the way that a custom object may be created, which in turn may be slightly different from a non-custom object (e.g., core object). In example embodiments, differences between creating a custom object and a non-custom object may include who may be allowed to do it (e.g., user-based determination), and for example, what set of permissions a user may have, otherwise it may be substantively a similar technical process. In substantially the same way that a customer or an integrator or a vendor may create a custom object, the systems and processes of registration patterns described herein may facilitate in creating a registration element which in turn may enable at least one of a custom object or even a standard object to interact with an application. A characteristic of the registration pattern may be that it may be used for a range of CRM objects, standard objects, and/or custom objects to provide CRM object content to a specific application feature. In example embodiments, a registration structure itself may not be a CRM object such that the registration structure may be stored in a home database. However, in example embodiments, the registration structure may be a CRM object itself. In example embodiments, there may be distinct registration elements for the standard objects and registration elements for the custom objects. In example embodiments, these objects may be stored in the CRM. In example embodiments, these objects may be portal specific and may be replicated across one or more of the portals.

In embodiments, a registration pattern may include a registration definition element that may be stored in a database, such as a CRM database. A registration definition element (also referred to herein as a registration definition) may allow pre-existing objects of the CRM (e.g., custom objects, core objects, object types, and the like) to be adapted for new uses and consumed by processes (e.g., onboarding a CRM asset to a project/application) without any of the following: (i) forcing use and/or processing constraints to require altering the pre-existing objects; (ii) requiring new code to be written and/or existing code to be modified for such use; and (iii) needing to maintain use-specific shadow objects in the CRM (e.g., that may contain at least a portion of the object being shadowed in a use-specific format). A registration definition may be configured to ensure that content from a CRM asset may meet consumer application-specific (e.g., a CRM-powered application, such as a calendar) requirements for content, format. Registration patterns may facilitate reduced computational resources, reduced data storage resources, and reduced network activity when onboarding new assets or when changing behaviors of assets already onboarded to (e.g., used by) a project/application. In an example, registration definitions as described and depicted in the disclosure may allow a pre-existing CRM object (e.g., webinar object, seminar object, and the like) to be processed for display by a calendar application, even when the pre-existing CRM object may include structures, formats, content, or the like that may not be fully compliant with calendar application input or use data requirements. Each type of project/application that consumes CRM data may be associated with a registration definition that may be specific to the project/application. This association may be one-to-one, with each project having a one-to-one association to a specific registration definition element in the CRM. This association may be one-to-many, optionally based on, for example, a type of project. With a one-to-many relationship, several instances of a project type “calendar” all share a single registration definition element.

In embodiments, a registration definition element that may be associated with a target project/application may include registration definition element instances (e.g., discrete portions of the registration definition element) for several types of CRM objects (e.g., seminar objects, webinar objects, blog posts, emails, campaign elements, and the like). A registration definition element instance may be seen as a configuration read by a project when handling a specific object type. In embodiments, a registration element instance may identify a set of criteria for CRM-sourced content to be consumed by, for example, a CRM-powered application. While this set of criteria may be consistent within the consuming application for at least a subset of all object types in the CRM, different object types in the CRM may store the consuming application's required information differently (e.g., may use different field names, may store the content in different formats, and the like). Therefore, while the required content may be consistent, a pattern by which information from the different types of objects may be registered may be different, resulting in, for example, source object dependent registration patterns.

In embodiments, a registration pattern may include a registration association element that may be stored in the database. A registration association element (may also be referred to herein as a registration association or in certain contexts an association) may be a variant of a registration pattern that allows establishing and/or maintaining continuity of content and/or structure of related pre-existing objects. This registration pattern variant may facilitate CRM database continuity through identifying objects and one or more fields therein to be monitored for change. In embodiments, a registration association element may be employed with a process for monitoring a CRM event stream (e.g., a log of events and/or active event stream) to facilitate detecting changes to objects in the CRM. A CRM event stream may include a CRM event (e.g., a change to a value in an object in the CRM) that matches at least a portion of content of a registration association may signify a change in the CRM that triggers a monitoring application to cause further CRM events to occur to ensure continuity in the CRM. An object type of “blog” may include a “source” field label that may be used by CRM-powered applications (e.g., ad campaign administration). A registration association element may be configured with this object type and this field label. Responsive to a CRM event monitoring application detecting a CRM event (e.g., in an event stream) that matches this registration association element, the monitoring application cause instances of the “blog” type object to be updated based on a change in the monitored field “source”. Use of registration associations when monitoring CRM events may facilitate factor-based CRM reporting (e.g., CRM analytics) across a CRM based multi-service business platform.

In embodiments, the methods and systems of registration pattern creation, configuration, use, and adaptation described herein may be further enabled through features of a host CRM, such as CRM-specific application programming interfaces (APIs) and the like. One or more CRM-specific APIs may facilitate uniform execution of read and/or write operations on objects in the CRM independently of a type of the objects. In example embodiments, use of such APIs with the methods and systems of registration patterns described herein may facilitate dynamically enabling use of several CRM object types for a specific use case (e.g., a CRM project, CRM-powered application, and the like, some of which are described herein) using unmodified use case software/code. Further such us of the APIs may avoid redeployment and/or modification of software/code, CRM-specific data structures, and the like. Benefits of such CRM-specific API functionality may include, among other things: (i) improved performance when using the CRM as compared to services that require such modification/adaptation; (ii) efficient CRM-independence of use case/user/service; (iii) efficient reuse of existing code thereby reducing the amount of use case-specific code to be maintained; and (iv) uniformity and consistency of CRM object structures, interface methods, and codebase that results in easier platform maintenance, debugging, etc.

Registration patterns (definitions and/or associations) may be established based on a range of factors and aspects of the CRM as well as consuming applications/processes. In example embodiments, when a new object type is defined in the CRM, such as a transaction-type object, one or more transaction type object registration definitions may be configured in the CRM. In example embodiments, a transaction type object registration definition may be created in the CRM for each consuming application so that each consuming application may seamlessly use/process the new object type by referring to its transaction type object registration definition. Further in this example, one or more registration associations may be defined and stored in the CRM to facilitate monitoring CRM event activity and maintaining continuity within the CRM for events that may impact the transaction-type object. In another example, when a new consuming application (e.g., a compliance application) is to initiate access to the CRM, one or more compliance application-specific registration definitions (e.g., one for each type of object present in the CRM contemporaneous with the compliance application initiating access) may be created and stored in the CRM.

In example embodiments, registration patterns may adhere at least in part to requirements of other objects in the CRM, such as use of syntax, taxonomy, structural elements like field definitions, and the like. In this regard, registration patterns may be defined, instantiated, and maintained in the CRM through one or more pre-existing interfaces, portals, applications, wizards, and the like through which objects, object types and the like may be defined, instantiated, and maintained in the CRM. Use of preexisting interfaces, tools, and the like may reduce complexity of a multi-service business platform, may reduce training time, may increase the likelihood that registration patterns may be adopted by users of the multi-service business platform, and the like.

Registration patterns may be configured with a range of functionality, including without limitation, mapping source object field values to consuming application fields, reformatting source object field values to conform with consuming application formatting needs, establishing and/or signaling use of default values for consuming application data that may not be provided by a source object, indicating whether an object type may be used (activated) or may not be used (deactivated) by the consuming application, and the like. Further, records (e.g., registration definition elements) may be created in the CRM to register other records (e.g., email objects, contact objects, and the like) with, for example CRM-powered applications. In this way, and optionally when combined with CRM-specific APIs, a registration pattern-enabled CRM may self-adapt for a wide variety of uses without, among other things, external sets of mappings of source object content to consumer (e.g., application) content or CRM-specific access code created content for and/or associated with each individual use case/application. In example embodiments, a registration pattern-enabled CRM may facilitate mapping attributes of source objects to specific fields required by any application that accesses (e.g., reads or writes) the CRM. Therefore, not only may the CRM be constructed and operated optimally for meeting requirements of a hosting multi-service business platform, but the CRM may be made accessible to external services by merely creating registration patterns for the external service.

By storing the registration patterns as object/elements in the CRM, the CRM may become its own configuration and adjustment mechanism. This enables independence of the CRM so that there may be no other system, no other interfaces, and no need for any system, application, third-party, or the like knowing about the details of objects in the CRM. Each registration pattern that is created for each object (e.g., object type) may hold the details about how to use the information in the object in the CRM to satisfy the system/application/third-party information requirements.

In example embodiments, a registration pattern map may attribute properties of the source object (e.g., Email Sent Date) to generic fields required by the application to which the source object data may be applied/used (e.g., start date for an event in the calendar). This pattern may be used with different applications/systems (e.g., calendar system and/or campaign system). In example embodiments, creating registration patterns and some custom objects may be accomplished through the same process and the same portal, such as the same form filling API used for custom objects. In example embodiments, it may be the same API, even though the logic performed by the API (e.g., in the background) may change. However, a standard object may be stored with a different data server than a custom object or registration pattern, due at least in part different freight limiting and other aspects that may not be needed for custom objects. In example embodiments, when trying to register a custom object, the system may execute logic for custom objects. When trying to create standard objects, the system may execute logic required for the standard objects. However, the interface (e.g., representation of the registration element to the user) may be the same. In example embodiments, the system may store the same kind of information for both of these (e.g., registration elements and custom objects).

In embodiments, a registration pattern (e.g., registration definition element, registration association element, and the like) may be configured through a process that may include several actions. One such action may include identifying a target consumer application/user/project of information stored in objects in the CRM. Another such action may include identifying content types that may be required for use by the target consumer application/user, such as dates, links, and the like. An example target consumer of CRM object information may include CRM-powered applications, such as a calendar application/service, a performance monitoring (e.g., analytics) application/service, an ingestion application/service, a CRM access application/service (e.g., CRM-access API and the like), a data conversion service, a third-party application, and the like. When one or more content types may be identified for the target consumer application/service, corresponding source fields for one or more (optionally all) types of CRM objects may be determined. As an example, a start_date field of a calendar application may require a particular source date content to ensure that the calendar application may populate aspects of the source objects from the CRM in the proper date. Information in a campaign-type object in the CRM may include several date fields (e.g., a date field that defines a trial period, a date field that defines when the campaign object was created, another date field for when a targeted advertising action of the campaign is to start, and the like). In example embodiments, a date field of the campaign-type object may be determined to correspond to the start_date field of the calendar application through use of automated and/or at least partially with manual activity. Date fields of other object types in the CRM may be determined to correspond to a start_date field of a calendar application. This process may be repeated for each target consumer application/user in combination with each object type defined in the CRM.

In embodiments, a process to create a registration pattern, such as a registration definition may include identifying content types (e.g., dates, links, etc.) that may be required for a target consumer application/portal/user, such as a marketing calendar application, and the like. The process may include, for each CRM object type, determining which source field may correspond to each of the identified content types. From this information, a CRM compatible object/element, such as a target consumer-specific registration definition that facilitates the correspondence may be arranged in a form that makes plain which source object and field corresponds to which target consumer content field. In embodiments, a process by which the registration definition created as described above, or otherwise created, copied, accessed, provided, or the like may be used and may include accessing the target consumer-specific registration definition. Based on object type properties of the retrieved registration definition, the system may receive/retrieve object(s) of the identified type from the CRM to be processed. In example embodiments, a record, optionally stored in or in association with the CRM (e.g., in an object processing tracking history), may identify object(s) of the CRM that may have already been processed. For each object of the identified object type accessed, the registration definition content (e.g., the map of object properties to target-user properties) may be used to map source object field values into target consumer-required fields. The resulting data may be used by the target consumer/application to perform its function, such as populate a calendar for rendering in a user interface.

For a given target-consumer/source CRM object-type combination, a CRM compatible element (optionally an object of the CRM) (herein referred to as a registration definition element) may be created to facilitate use of the corresponding date information in the source CRM object-type. Information structured into a registration definition element may include source object type and corresponding field and target consumer application fields for several source object types. A registration definition element may be created in a CRM database using tools, interfaces, and other existing object creation and maintenance functions that may be used to create CRM objects for the CRM database. A registration definition element may be created for each target-consumer application/user. Each such registration definition element may include field correspondence statements for several different types of CRM objects. These field correspondence statements may be grouped within the registration definition element as a source-object type-specific registration element instance. As an example, a target-consumer application-specific registration definition element may include correspondences for date fields for an EMAIL object, a RECURRING EMAIL object, a CAMPAIGN object, and the like. In this example, other field correspondences for an EMAIL object (for example) may be grouped in an EMAIL registration element instance within the target-consumer registration definition element.

In embodiments, a target-consumer application/user may be configured to access and apply a registration definition element when attempting to access content of a source object in the CRM. The object type of the source object in the CRM being accessed by the target-consumer application may be used to identify a portion in the registration definition element that may facilitate mapping the relevant fields of the source object. The field mappings in the registration definition element may be used to map field values from source fields of the source object to corresponding fields of the target-consumer application/user. The mapped source field content may be used by the target-consumer application/user to perform a function, such as populate a calendar, transmit object data to a third party, perform analytics on the CRM, and the like. In example embodiments, field mapping may be performed in batch mode with results of field mapping being stored in an intermediate CRM element that may be directly accessed by the target-consumer application. In other example embodiments, field mapping may be performed contemporaneously with execution of the target-consumer application. An API may be configured as a registration definition element handling service, such as to retrieve data from the CRM, process the data per the registration definition element, and deliver the processed data to the target-consumer application.

In embodiments, a calendar application, such as a marketing calendar for use in managing a multi-service business platform may be CRM powered in that it may include a set of tasks for updating the calendar based on content of the CRM. An example calendar application may integrate different types of assets to be added to the calendar application. Examples include email campaigns that may be going out, sharing social media posts, entire campaigns, collections of assets, blog posts, etc. The methods and systems of registration patterns and the like may facilitate bringing content in the CRM (e.g., in and associated with objects) to the calendar easily and quickly. Such a process may be referred to as a registration-activated calendar update that may be an extremely powerful CRM-application integration tool. Initially, a calendar application may request available object-specific registration definitions (e.g., distinct registration definitions for blog posts, landing pages, social media posts, etc.). In example embodiments, use of registration definitions (e.g., CRM registration definition) with the calendar application allows for the calendar application to integrate content of objects in the CRM associated with each of these registration definitions into the calendar (e.g., a blog post registration definition may enable integration of the properties of the blog post with the calendar.)

In this example of a calendar service, the calendar looks up its registration elements (e.g., looking for data such as name and/or what is being shown in the calendar). A registration definition may be useful when any application accesses a CRM database at least as a filtering mechanism that may be structured to facilitate restricting access to the CRM so that the requesting application is not shown (e.g., provided access to) content that may not be in the calendar. Further, a registration pattern definition may be useful for ensuring that content of properties of a source object may be determined for a minimum set of content required by the calendar application, such as the start date, which may be critical for rendering content on calendars. In example embodiments, these are the kinds of definitions may be part of a calendar registration definition.

As the calendar application loads, it may request from the CRM the registration elements identified as calendar registration definitions. For example, there may be a registration definition for blog posts, a registration definition for a landing page, a registration definition for social media posts, and so on. A start date of the blog post on the calendar may be a corresponding date field of the blog post objects. In addition to facilitating mapping object properties to calendar content fields, calendar rendering aspects, such as a preferred background color to be used when highlighting the blog post in the calendar may be a default highlight color field on the CRM object. As described herein in a range of example embodiments, a registration pattern may essentially be a set or collection of configurations and mappings from a pre-existing CRM object to what the calendar expects. A CRM access capability of the system may then know how to query for the CRM objects, and how to transform properties into a standard (e.g., compatible) representation for the calendar.

In example embodiments, a CRM access capability may be configured as an API end point that may, for example, fetch a list of blog posts CRM objects, and convert/deliver content of certain properties to the calendar based on the applicable registration definition. In example embodiments, CRM content fetched may include several JSON data structures representing blog posts objects in the CRM. Further the system may include an API to feed data from the registration-based CRM access API to the calendar. In summary, a process for creating a calendar event with the registration methods and systems described herein may include taking the list of objects from the CRM, and applying the configuration and rules in the registration definition to produce a standard calendar event. In example embodiments, applying a registration definition for populating a calendar may cause an impact on data structures of or associated with a calendar application that may populate the calendar. In example embodiments, a CRM object may include identified fields and/or field values that may be processed with a corresponding registration definition to generate and/or impact data structures, such as fields and/or values of a target CRM object (e.g., a calendar instance object), or configure and/or generate a CRM object that may be used by (e.g., accessed within the CRM) a calendar application for performing calendar functions, such as populating a calendar and the like. In example embodiments, identified fields and/or field values of a target CRM object may be processed by a registration definition(s). A result of the processing may be provided to a calendar application, such as in a stream of calendar population values from which a calendar may be populated.

Further, in this calendar example, the list of registration patterns for the calendar may include a landing page. This registration element may be created in order to make sure that the landing page objects are properly rendered in the calendar. In this example, there are many fields that embody the kind of information that a registration definition possesses for the calendar use, such as: the object ID, the name of the object, and the like. The registration definition may answer questions for the calendar, such as what is the property that is keeping an ID for landing pages?; what is the property keeping track of the published date for the landing page objects?; and what is the property keeping track of the name of those objects? In example embodiments, this registration may facilitate fetching, from the CRM, the properties that may be needed in order to properly render landing page objects in the calendar.

In embodiments, the methods and systems of registration patterns may provide flexibility for CRM operation because if key properties required by the calendar change, it may be possible that all the landing pages may not be rendered by the calendar anymore. The CRM may be updated to cause a change in how to store the start date in landing page objects. To accommodate such changes for all objects, only the registrations may need to change. In example embodiments, a seed registration may have a dynamic configuration that may be updated (e.g., by developers and the like) in order to ensure that some changes in the CRM may be reflected in the calendar or in general, in the example use case that uses the registration pattern. In embodiments, registration definitions may be standardized across portals so that no matter what portal is accessing the CRM, the view may be consistent for the corresponding object types. However, custom registration definitions (e.g., created for customer objects) may provide customers with registration definition-level control over use of customer objects. In example embodiments, a customer may define and configure a home webinar object in the CRM. These custom webinar objects may be shown in the calendar by use of a custom webinar object-specific registration element instance being configured, optionally by the customer, using the methods and systems of registration definition creation herein. In example embodiments, the methods and systems of registration patterns may be adapted to allow specific portals (e.g., customers and the like) to create registrations for their home custom objects. In example embodiments, integration of object content into a calendar and/or into a structure to be reported, may be controlled on a user-specific basis through use of custom objects and custom registration definitions for those objects.

Fields within the registration definition may provide various configurations and mappings that may be executed by the calendar system (e.g., start date field, preferred background color field, etc. in the blog post registration element). In the calendar use case, a minimal set of corresponding fields in the CRM object may be required, which in this case may include the start date, property, and the title property, and optionally the object ID property. If a CRM object type has at least these properties, the CRM object type may be registered for (integrated into/with) the calendar. As an example, if a first object type does not have a title property, then it may not be possible to show the first object type in the calendar. As noted herein, not all target consuming applications/portals/users may require the same source object properties. For example, campaign applications may not require all of the property fields that a calendar application may require. In an example of integrating a marketing email object with a calendar, different properties may be required for the marketing email to be properly shown in calendar. In example embodiments, other properties may not be mandatory. However, some non-mandatory properties may enable some calendar features, such as object preview. Therefore, if a preview property is configured in a marketing email object, the calendar UI may provide user access to the preview key as well.

In example embodiments, comparable properties on different object types may be given the same identifier (e.g., object ID), although that may not be required. A first object may define the ID property with one name, but another object may define the ID property with a different name. The methods and systems of registration patterns may allow two different properties in two different objects to have the same name, while ensuring that each is mapped properly when each object is processed by its corresponding registration definition (e.g., for use by an application such as the calendar application).

In embodiments, query registration definitions may be transformed into standard representations for a calendar application. Example embodiments may include using a calendar system to look up registration definitions (e.g., look for data properties such as name and/or what is shown in the calendar including start date). In example embodiments, registration definition required fields may include primary ID, definition name, definition type, properties such as start date, and the like for use with the calendar system. In embodiments, an API may be configured for use as an interface between an application (e.g., calendar) and the CRM. An example may include an API used to fetch registration definitions (e.g., blog posts CRM objects which may be JSON representing blog posts objects in the CRM). This example may include an API that may feed data from the CRM to be transformed and formatted for an application (e.g., calendar application). This example may include a list of registration definitions from a CRM that may include configurations and rules that may be applied as part of obtaining a standard calendar event (e.g., feed of data pre-transformation and post-transformation for each registration definition). In embodiments, there may be a level of common functionality to registration patterns that may be applied across objects, applications, and CRM elements in general. In example embodiments, an application may feed off data from the CRM. A registration pattern may be keyed to one of several types of objects. In embodiments, a registration pattern may have a set of data that may apply to any use of the registration pattern. Also, a registration pattern for a calendar application may define a set of “must have” fields such as start date as described herein. This example of a data item in the set of data that, while it may apply to any use of the registration pattern, may be accompanied by application-specific transformation and configuration data.

In embodiments, a calendar application use of registration patterns is described in the disclosure. Prior to use of a registration pattern by a marketing calendar application to render events on the calendar of different object/asset types, the application may fetch the relevant data from several objects in the CRM. In this example, the CRM may be a multi-service business platform CRM database that may include different types of CRM objects for several platform users. The calendar application may seek to render select assets for the users in one calendar view. Therefore, the calendar application may retrieve CRM object content from a range of asset types and user-specific objects and render the respective calendar events accordingly. For some examples, in addition to needing to discern specific portions of different types of assets for a single user, having to deal with several users may require a substantive amount of code development and maintenance that may cause a negative impact on the platform codebase, on the platform metrics, and on the overall platform performance. Further, in some examples, a lack of homogeneity may make onboarding new assets to the calendar tedious and error prone as more and more complexity may be added to the calendar application codebase. This greater complexity may contribute to overall platform performance degradation.

Use of the methods and systems of registration patterns may resolve and/or eliminate these complications, performance cost, and complexity. The example calendar application (and generally most such applications that access a CRM) may use fetching logic of the CRM. That fetching logic complexity may be reduced so that a single fetching logic (e.g., program code) may be used to fetch content from all different types of CRM objects or assets for all different user objects stored in the CRM. Typical operational activity of the platform, such as onboarding a new asset to the calendar (e.g., rendering a newly created campaign in the calendar and the like) has been turned from a tedious error-prone process that may result in impacting rendering of other assets into a simple registration definition creation process using CRM-object creation tools. This improvement may be exemplified by each registration element instance in a registration definition element being responsible for onboarding of a specific asset type. The registration element instance may contain at least a mapping of properties on the CRM object to fields on a common calendar event object. Prior to use of registration patterns, the mappings between specific assets and calendar events (e.g., between CRM object fields and calendar object fields) were statically coded for each asset. This required having several entities responsible for onboarding each individual asset type to be rendered in the calendar. With registration patterns, a single entity may be configured to receive a registration element instance with a corresponding CRM object and deliver a conforming calendar event data set that may be rendered by the calendar application.

Further, in this registration pattern example for use by a calendar application, a calendar application may request registration definition element(s) configured to facilitate onboarding of calendar events based on select object (types/assets) in the CRM, such as blog posts, landing pages, social media posts, and the like. A CRM-interface portion of the calendar application, or optionally a CRM-interface service of the CRM such as a CRM-specific API and the like, may use the information that identifies each registration element instance in each registration definition element to identify assets in the CRM to be accessed. In example embodiments, a calendar application may target a specific CRM asset when requesting the registration definition element(s), such as when a user may adjust a view of the calendar to include an asset not currently rendered in the calendar. Content of the targeted assets may be retrieved and values from fields identified in a corresponding registration element instance may be selected and configured for delivery to the calendar application. Configuring these selected values may include generating a data set that attributes each selected value to a specific field/attribute of the calendar application. A value of the CAMPAIGN asset field “hs_campaign_start_date” for a selected CRM asset may be attributed to the calendar required field “startDateProperty”. The calendar then may use this value to render the CAMPAIGN asset on the proper date in the calendar.

Further, in the example, the MARKETING_EMAIL registration definition element instance may be enabled for use by the calendar or disabled for use. The value in the registration definition element instance entry labeled “isEnabled” may be used for such a purpose. When the entry labelled “isEnabled” given a value of “true” as depicted in FIG. REG02, then the calendar application may render CRM objects of the type “MARKETING_EMAIL”. If the same entry value was not “true” (e.g., “false”), then the calendar application may not render CRM objects of the type “MARKETING_EMAIL”. In embodiments, registration definitions may facilitate distinguishing between two different variants of an object type. The specific variant of object type “MARKETING_EMAIL” to which this registration definition applies may be an “email” variant as determined by the “crmObjectDisplayName” field. Rendering of other variants of “MARKETING_EMAIL” by the calendar application may be separately controlled.

Further, the calendar field “gateName” may be configured for each registration definition element instance. Use of this field may further determine conditions under which the registration definition element instance may be utilized. When this field is “null”, the registration definition element instance may be used without further gating. However, when this field is not “null”, conditions associated with the “gateName” specified may be considered when determining if and how this registration definition element instance is to be used. In example embodiments, example core objects (e.g., object types) that a calendar application (or other application) may process through the methods and systems of registration patterns described herein may include, without limitation: publishing_task/task, marketing email/email, marketing_email/recurring.

A user interface is provided through which registration definitions for a calendar application may be selected for onboarding a corresponding CRM asset/object. The highlighted drop-down list may be used to select one or more asset types to be rendered in the calendar. Selection (e.g., checking a corresponding checkbox in the drop-down list) may cause a CRM fetching service to access a corresponding registration instance within a registration definition element for the calendar application. All of the available event types may be selected. For the remainder of this example, the event type is referenced. In example embodiments, the CRM fetching service may access corresponding registration instances for event type. In example embodiments, the fetching service (or the like) may proceed to retrieve data from each LAG object in the CRM, apply the registration instance mappings for a LAG object type, and deliver the resulting content to the calendar application. The result may include one or more lead generation rendered on the calendar. The processes described in this example may leave the source object(s) (e.g., all LAG-type objects) in the CRM database unchanged, while ensuring that each may be properly rendered in the calendar.

In embodiments, registration patterns may include a variant referred to herein as registration associations. Registration associations may facilitate, among other things, maintaining consistency across objects within a multi-service business platform database, such as a customer relationship management (CRM) database. Registration associations may facilitate adding new associations among objects and/or updating existing associations based on actions on or within the CRM. In example embodiments, existing associations may be cleared/removed or updated for maintaining consistency. In embodiments, registration associations may define one to one associations (among assets of the platform, such as objects of the platform) and one to many associations. In embodiments, registration association type patterns may allow associating an object with a different type of object, such as to a campaign. The example of one to one or one to many association may include associating one blog post to one campaign in a one to one registration association relationship. In an example of changing a one-to-one relationship association, if a blog post, e.g., “the best blog post ever” is associated to a first campaign, an association status for this blog post may show that it is currently part of (e.g., associated with) this campaign. If that blog post association is changed, such as by attempting to associate it to a second campaign, through application of the methods and systems of registration association described herein, it may be removed from the first campaign because, in this example, one blog post may only be part of one campaign.

In embodiments, a many to many asset association may include association of a workflow. In this example, a user (or system process or other automated process and the like) may add a first workflow to a first campaign. If one were to add the first workflow to a second campaign, the system may accept this second association of the first workflow without removing it from the first campaign because, in this example, one workflow may be part of multiple campaigns. In embodiments, a control for whether or not an asset may be used in a one-to-many association may optionally be indicated by an association definition index value recorded in the registration association data structure. In an example of a registration data structure that uses a JSON syntax, this value may be retrieved from an “association ID” property of the registration association data structure.

In embodiments, a value of an “association ID” may be used by the system to retrieve a related data structure (optionally referred to as a definition of the registration association) that may provide greater/other details of a registration instance. This related data structure may include information that determines if the asset type to which this registration instance applies (e.g., is identified in a “toObjectType” property of the instance) may be used in a one-to-many relationship.

In addition to handling asset association relationship modes (one-to-one and one-to-many), the association variants of registration patterns herein may be used by a CRM activity monitoring service of the platform that may be utilized to process updates to objects for consistency across the platform (e.g., updating of associations such as a blog post belongs to a particular campaign, or the particular campaign has a blog post as described in the disclosure). In example embodiments, a worker system may monitor for changes in the CRM (e.g., changes to registration definitions, campaigns, and the like that may require changes to associations). The registration association information from several object type-specific registration association element instances may be used (e.g., by the worker system) in determining specific changes (e.g., type of object, properties, and/or associations of the object) that may be required for consistency. The worker system may query a source of data that may include changes to one or more objects (e.g., a CRM ingestion/activity stream and/or log) for activity associated with an object type defined in one of several registration association element instances being used by the worker system to determine if certain properties have changes (e.g., value present in property may have changed). If CRM change activity matches the information in the registration association being used by the worker system, one or more objects (e.g., campaign objects) may need to be changed based on that property change (e.g., property change may be moving of blog post from one campaign to another campaign).

In embodiments, managing campaigns in a CRM may rely on registration definitions to facilitate processing what may be complex multi-object updates (e.g., process updates to objects to ensure associations and related aspects of a campaign stay consistent). An “association” action may be based on a “registration association” as described herein that may be substantively equivalent to a database “join” operation. For example, to achieve consistency so that there is no doubt when accessing the CRM that “this blog post” belongs to this campaign, and this campaign has “this blog post” in it, registration associations that relate “this blog post” with this campaign may be used.

A worker system (e.g., a platform service and the like) may use registration elements as the worker system listens to a stream of change events in the CRM. Worker system may also be referred to as worker service. For each event, the worker system may monitor changes to one or more object values defined by a registration association for the object type identified in the event to determine among other things how the CRM may have changed, such as how a campaign associated with the object type identified in the event may have changed. If the campaign has changed, the worker system or service may attempt to update all the associations of the campaign and keep the CRM consistent. A registration element used by that worker service may identify a type of object and what fields of the object may be monitored for changes in the event stream. Based on changes in that field, the worker system may determine which associations should be updated, which ones should be cleared out, which new ones should be created, etc. In embodiments, the worker service or system may perform these association consistency updates independent of the object being a custom object or a standard core object. In example embodiments, how a registration element is structured (e.g., the property that it checks for and the like) may change for each different application/use.

In embodiments, one may use the registration associations for doing associations of assets with the campaign. In example embodiments, a registration may include a set of definitions for processing items. For example, an example registration may facilitate a worker service in determining if, in the CRM, any object of the type “automation platform flow” changes, and if a property (e.g., campaign GUID property “hs_campaign_guids”) specifically changes, then the value which may be present in the change event for that property may be associated with the object that has been changed. For example, an object of type “automation platform flow” that has changed may be considered. The value of a property may have changed (e.g., campaign GUID score changed). In example embodiments, the worker service may automatically do the association of the “automation platform flow” (which has changed) with the corresponding campaign. This example of registration patterns relates to managing of associations between objects in the CRM. A type of registration association data structure for use by a worker service may include only a few sets of fields such as fields relating to object type being monitored and the field being monitored.

The worker service may use this registration element to find a type of object in the CRM (e.g., “automation platform flow”) with a specific property (e.g., “hs_campaign_guids”). When the worker service finds the object of the type “automation platform flow” in the CRM, the worker service may attempt to find whether the “hs_campaign_guids” property has changed based on what is found in the CRM and what is provided in the CRM change event stream. If this property has changed, then a campaign identified by this “hs_campaign_guids” campaign value may have this “automation platform flow” associated with it. In example embodiments, the worker system, which does this monitoring for any changes in the CRM, may monitor everything that is changing in the CRM using filters that may be based on the registrations, and then may do the work of associating assets in the CRM based on what has been configured in the registration association.

In embodiments, there may be several applications that move assets in and out of campaigns. It may require monitoring and possible adjustment of the code of these applications such as making changes to keep the associations straight and up-to-date. The CRM may emit a constant stream of events. Every time anything changes such as a definition, an object, or an object instance, there may be an event in that stream. The worker service that uses registration associations may be monitoring the stream for all of these changes. For example, if a user took a blog post and moved it from a first campaign to a second campaign, that change may generate an event in the stream. The worker service may monitor (e.g., listen) for such an event and determine that the blog post had its campaign field updated to reflect the second campaign. The worker service may check the second campaign object (that may be defined in the updated campaign field in the blog post change event) and may make sure that the second campaign object reflects the new campaign assignment. In example embodiments, such a worker service or system may be a CRM internal tool to keep the associations between objects in the CRM up-to-date. Rather than changing the database in some examples, this worker system or service may be adjusting the association (e.g., changing the graph data). In example embodiments, applications may be changing the database and may also be updating at least portions of the CRM. This registration association-based worker service/system may monitor the portion of the CRM that may be changed to determine what else in the CRM may be impacted by the change, thereby centrally implementing the change across the CRM for objects and/or object types identified in the registration association employed by the worker service. This central implementation of CRM changes through use of registration associations may eliminate the need for requiring the change be made by every individual application that may make use of the CRM.

In example embodiments, registration patterns may include variations that may facilitate updating portions of the CRM based on monitored CRM events, such as activities of sources of changes to other portions of the CRM. In example embodiments, such a registration pattern variant may be a registration association that may be configured to facilitate identifying an object type and at least one field of that object type to be monitored. When a CRM activity monitoring service, that utilizes registration associations, detects an event of the CRM that identifies an object type noted in the utilized registration association, the content of the event (e.g., what the event is causing to be accomplished in the CRM to the object type) may be checked to determine if it impacts the field of the object type defined in the registration association. When the content of the event matches both the object type and the specific field identified in the registration association object, an association CRM activity may be activated.

An activity monitoring service may monitor CRM activity based on the registration association element. The activity monitoring service may look in the monitored activity for event content that may signify that an object type “LANDING_PAGE” is being targeted for some action (e.g., reading a value in the object, writing/updating a value of one or more fields in the object, and the like. When the monitored event identifies the object type “LANDING_PAGE”, the event may be further evaluated/monitored to determine if a specific field or fields of the object type are being acted upon by the event. The registration association for the object type LANDING_PAGE indicates that actions taken in the event against object field “hs_campaign_name” are to be followed up for maintaining consistency in the CRM database. When the event reflects that the object field “hs_campaign_name” is being/has been assigned a value (which is optionally the same as the current value or may be a different value than a current value), action may be taken within the CRM to ensure consistency as required based on the change. In example, a registration association element may identify a “blog post” field of a “campaign” object for monitoring by a CRM event activity monitoring service. When a CRM event matches this registration association element, a new value in the “blog post” field that may be defined in the event may be used to update portions of the CRM database for maintaining consistency. Some applications that have access to the CRM may be making changes that require updating the CRM. The activity monitoring service may use registration associations to determine if the change being made requires other changes in the CRM for consistency. Such an approach may reduce the burden on such applications of ensuring that CRM database consistency is maintained. In example of use of registration association elements, information in the registration association may facilitate identifying what the CRM consistency application may need to do when a specific field in a specific object type is acted upon. In embodiments, a CRM activity event may detect where a value of an attribute in a CAMPAIGN object is changed in the CRM. There may be other CRMs that may be impacted by such a change. In embodiments, a CRM consistency service may use the change of object information identified in the association registration to query the CRM for other (e.g., related) objects that rely on the now changed object field content. As the CRM consistency service finds other impacted objects, it may change them so that the now changed object content may be propagated to the other related objects.

In example embodiments, example applications of registration definition use may include being used with a calendar system (e.g., internal calendar application) and/or a campaign system. As described herein, registration definitions may be used to display scheduling of advertisements on a platform calendar. In example embodiments, these registration definitions may be tied to a payment system (e.g., allowing for payments for events using the payment system or tool).

In example embodiments, use of registration definitions with an analytics system may facilitate determining analytics from CRM activity, such as the number of clicks during an advertisement published on a CRM calendar and the like. In example embodiments, examples may include use of the registration patterns methods and systems described herein to create CRM events such as counting of clicks and the like. The registration definitions may be used with an analytics system to process events for monitoring activities related to the events (e.g., who signed in for an event that the customer is running for their product). Potential touch points may include who is registering, how did they register, what source did they register from, etc. (e.g., relating to signing up for events such as hosting webinars).

Other examples for use of registration definitions. In example embodiments, a CRM analytics system may be used to determine, for example, how many times a blog post has been clicked through the use of registration definitions to create CRM blog post click events. Another example use case may include an online university use of course objects with corresponding registration definitions to facilitate integration of the course objects into the calendar system and/or the campaign system. Yet another use case for registration patterns may include use in attribution reporting systems.

Benefits of registration patterns is that third-parties may not be forced to adhere to a unique standard (e.g., one that may be different than the third-party's standard) when third parties create their own (e.g., custom) objects and use them within the multi-service business platform CRM. This may relate to third-party CRM use/access examples. The methods and systems of registration patterns described herein may provide benefits to third-party CRM use and access. In an example, a customer may define a custom class CRM object that they have been using for a period of time (e.g., one or two years or more). In this example, when the customer finds a vendor (e.g., with a system/service that they want to use with their custom class CRM objects), there is no need for either the customer or the vendor to change their systems—both may keep their objects as they were and the vendor may keep their system in place. If the vendor or the customer uses the example registration pattern methods and systems, interfacing between the customer custom class CRM and the vendor may be done through automatically transforming data without requiring any new code to run. In example embodiments, registration patterns, such as registration definitions may allow for custom object use and creation by third parties. The registration patterns (and supporting CRM access APIs and the like) may be configured with external endpoints through which third parties may access the CRM for their own tools in order to, among other things, visualize custom registration patterns, create new elements or objects, update custom objects in the CRM, and the like. Also, in example embodiments, a customer may operate an external CRM system and may want to use the systems and processes of registration patterns to map these external CRM objects to objects and/or services of the multi-service business platform CRM. This may be accomplished by defining a set of registration patterns that may facilitate mapping the external CRM object properties to internal CRM object properties and use this set of registration patterns during exchange of data between the systems. In example embodiments, exchange of data between a CRM and external systems may include transforming data based on applied registration patterns (e.g., registration definitions). Transforming may include converting objects (or portions thereof) in the external system to be compatible with objects (or corresponding portions thereof) in the CRM. Registration patterns may also facilitate transforming data for compatibility when transferring CRM objects to the external system.

A range of CRM-centric capabilities may be enabled. In one example, a metering service may be configured to use registration associations to facilitate monetizing a CRM. Such a metering service may be configured to detect when CRM activity events, such as events by third parties, match a monetizing criteria (e.g., accessing certain fields of certain objects). Based on a CRM access arrangement with the example third party, the metering service may track and count such accesses to form a basis for payment by the third party, and the like. In another example, registration associations may be utilized by a CRM analytics service for, among other things, tracking activity within the CRM, such as for maintaining a log of access by specific users, services, and the like. Tracking may facilitate analytics pertaining to who is registering/accessing the CRM, what access portal did they use, what source device did they register from, what portion of the CRM are they accessing (e.g., users signing up for events offered through the multi-service business platform), and the like. Further, such an analytics system may facilitate adapting allocation to and usage of computing, network, and storage resources for the CRM based on a result of such analysis. If a distal portion of the CRM appears to be accessed frequently by local resources, changes in where the distal portion is stored may occur (e.g., move a highly accessed portion to a storage system that is physically closer to a point of use).

In example embodiments, use of registration associations to monitor CRM activity may cause CRM events, such as analytics that may, for example, increment a “view” counter for a blog post. In example embodiments, if the monitored event identifies that a blog post has been accessed (e.g., retrieved for viewing), the monitoring service that detects this event may update a “view_count” field of the blog post object. Registration associations may also be applied to tracking application activity within a CRM, such as when new assets are onboarded to a calendar (e.g., when higher education users post new educational class objects that trigger onboarding to the calendar, or when an ad campaign is changed such as a blog posting service requiring access to blog posts registered in the CRM, and the like).

In embodiments, at least one advantage of the method and systems of registration patterns may include using CRM interactions to allow the CRM records to be used in multiple applications. As an example, without this system and/or process, customers and integrators may need to learn/configure multiple systems in order to gain potentially comparable results. By using the CRM to power this process and/or system, there may be one consistent system, such as the multi-service business platform. Further, using registration patterns in the CRM to configure the CRM-powered application may avoid a need for a second API to interact with multiple applications. Advantages may include avoiding requiring a two-system approach. Another approach may include flexibility in using registration definitions with third party systems. Clients may keep using their objects with current systems (internal or external with respect to the platform). Also, data may be transformed when transferred into the platform. Yet further advantages may include requiring a reduced set of tasks for achieving a clean bridge between the CRM and the calendar application. Separation of data related to registration definitions from user to user may provide for unique customizability for users regarding each registration definition and its use. In example embodiments, customers or users may create registration definitions into the CRM via a customer/user portal which may be readily integrated with the platform (e.g., systems, services, features, etc. of the platform). When new applications are developed, existing objects (e.g., core objects and/or custom objects) may be integrated with the new applications via registration definitions with no need to modify the existing objects or develop custom code to accommodate specific object types allowing for the ability to speed up internal development and/or development by integrators.

The methods and systems described herein and depicted in the accompanying figures may present a range of advantages over other approaches. One such advantage may include using objects stored in the CRM (e.g., registration elements and the like) to allow the records in the CRM to be used in multiple applications. Another advantage is that customers/users, integrators, and others may no longer need to learn/configure multiple systems (e.g., their own CRM) to have access to content of the CRM. Thus, a registration pattern-enabled CRM may be embodied as one consistent system that may: (i) use objects in the CRM to configure CRM-powered applications; (ii) avoid need for multiple APIs for interacting with multiple applications; and (iii) avoid constraints of a multi-system approach. Users of a multi-service business platform may keep using custom objects stored in the CRM while gaining advantages of CRM-powered (and third-party powered) applications. Third-party systems may use existing interfaces to access the CRM. Clients of the multi-service business platform may utilize existing content creation tools (e.g., tools by which they generate content for the CRM) to generate registration patterns. New applications, projects, services, and the like may be developed, and third-party applications may be integrated into the platform, without requiring substantive development of code, converters, or the like as part of the integration.

In some embodiments, the described methods and/or their equivalents may be implemented with computer executable instructions. Thus, in some embodiments, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on. In some embodiments, a computing device is implemented with one or more executable algorithms that are configured to perform any of the disclosed methods. It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

Methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), electrically erasable programmable read-only memory (EEPROM) and/or flash memory, compact disk read only memory (CD-ROM)s, CD-Rs, compact disk re-writeable (CD-RW)s, DVDs, magnetic tape, optical or non-optical data storage devices and/or any other medium which can be used to store data.

Some examples of the claimed subject matter have been described with reference to the drawings, where like reference numerals are generally used to refer to like elements throughout. In the description, for purposes of explanation, numerous specific details are set forth in order to provide an understanding of the claimed subject matter. It may be evident, however, that the claimed subject matter may be practiced without these specific details. Nothing in this detailed description is admitted as prior art.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims. Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments. Furthermore, the claimed subject matter is implemented as a method, apparatus, or article of manufacture using standard application or engineering techniques to produce software, firmware, hardware, or any combination thereof to control a computer to implement the disclosed subject matter. The term “article of manufacture” as used herein is intended to encompass a computer application accessible from any computer-readable device, carrier, or media. Of course, many modifications may be made to this configuration without departing from the scope or spirit of the claimed subject matter. As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, an application, or a computer. By way of illustration, both an application running on a controller and the controller can be a component. One or more components residing within a process or thread of execution and a component may be localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”. Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method comprising:
generating a first campaign of a content sequence to include a first content item to display to a first audience of users of a platform;
generating a second campaign of the content sequence to include a second content item to display to a second audience of users that viewed the first content item;
generating a third campaign of the content sequence to include a third content item to display to a third audience of users that interacted with the second content item; and
implementing the content sequence through the platform.

2. The method of claim 1, comprising:
generating and implementing an exclusion list to exclude users from being provided with the first content item, the second content item, and the third content item based upon the users having a customer lifecycle status.

3. The method of claim 1, comprising:
generating and implementing an exclusion list to exclude users from being provided with the first content item based upon the users submitting a form associated with the second content item.

4. The method of claim 1, comprising:
generating and implementing an exclusion list to exclude users from being provided with the first content item based upon the users interacting with the second content item.

5. The method of claim 1, comprising:
generating and implementing an exclusion list to exclude users from being provided with the first content item and the second content item based upon the users interacting with the third content item.

6. The method of claim 1, comprising:
dynamically updating an exclusion list of users to exclude from being provided with a content item of the content sequence.

7. The method of claim 1, wherein the first content item comprise a video, and the method comprising:
turning off the first campaign based upon a determination that a threshold number of users have viewed at least a threshold amount of the video.

8. The method of claim 1, comprising:
turning on the second campaign based upon a threshold number of user viewing the first content item.

9. The method of claim 1, comprising:
defining the second audience of users for the second campaign as users that have viewed the first content item, wherein the second audience of users excludes users yet to view the first content item.

10. The method of claim 1, comprising:
generating and implementing an exclusion list to exclude users from being provided with the second content item based upon the users interacting with the second content item.

11. The method of claim 1, comprising:
triggering a workflow to perform an action based upon a user interacting with the second content item.

12. The method of claim 1, comprising:
sending at least one of a first notification to an owner of the content sequence that the second campaign has started or a second notification to the owner of the content sequence that the second campaign has ended based upon an end criteria being satisfied.

13. The method of claim 1, comprising:
associating the first campaign with a campaign urchin tracking module generated from a globally unique identifier, wherein the first campaign is represented as a campaign object within a customer relationship management (CRM) system, and wherein the campaign object is associated registration definition element.

14. The method of claim 1, comprising:
defining the third audience of users for the third campaign as users that have submitted a form associated with the second content item, wherein a contact list of users is created from submissions of the form by the users.

15. The method of claim 1, comprising:
providing the third content item to users through a plurality of platforms including the platform.

16. The method of claim 1, comprising:
turning on the third campaign based upon a threshold number of user submitting a form associated with the second content item.

17. A non-transitory machine-readable storage medium comprising instructions that when executed by a machine, causes the machine to:
implement a first campaign of a content sequence to include a first content item to display to a first audience of users;
implement a second campaign of the content sequence to include a second content item to display to a second audience of users that viewed the first content item, wherein the second campaign is implemented based upon a threshold number of users viewing the first content item; and
implement a third campaign of the content sequence to include a third content item to display to a third audience of users that interacted with the second content item.

18. The non-transitory machine-readable storage medium of claim 17, wherein the instructions cause the machine to:
generate a report indicating a first number of users that interacted with the first content item, a second number of users that interacted with the second content item, and a third number of users that interacted with the third content item.

19. The non-transitory machine-readable storage medium of claim 17, wherein the instructions cause the machine to:
provide a ranked list of videos for user selection as the first content item, wherein videos are ranked for inclusion within the ranked list of videos based upon prior engagement of users with the videos.

20. A computing device comprising:
a memory comprising machine executable code; and
a processor coupled to the memory, the processor configured to execute the machine executable code to cause the processor to:
implement a first campaign of a content sequence to include a first content item to display to a first audience of users, wherein a first set of exclusion rules are applied to define the first audience of users for the first campaign;
implement a second campaign of the content sequence to include a second content item to display to a second audience of users that viewed the first content item, wherein a second set of exclusion rules are applied to define the second audience of users for the second campaign; and
implement a third campaign of the content sequence to include a third content item to display to a third audience of users that interacted with the second content item, wherein a third set of exclusion rules are applied to define the third audience of users for the third campaign.
